(19) United States
(12) Patent Application Publication
(10) Pub. No.: US 2009/0268595 A1
(43) Pub. Date: Oct. 29, 2009

(54) INFORMATION RECORDING MEDIUM AND RECORDING/REPRODUCING APPARATUS

(75) Inventors: Narutoshi Fukuzawa, Tokyo (JP); Katsuyuki Nakada, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 12/109,661

(22) Filed: Apr. 25, 2008

(51) Int. Cl. G11B 7/24

(52) U.S. Cl. 369/275.3

(57) ABSTRACT

On an information recording medium, a first region where first recording regions that are long in a radial direction are disposed at a predetermined pitch with first non-recording regions in between is provided in a preamble pattern region. A second recording region that connects first recording regions that are adjacent in a direction of rotation is provided in the first region. A second non-recording region that is longer in the direction of rotation than a length in the direction of rotation of the first non-recording regions at corresponding same-pattern-radius positions is provided at a position where a read of servo data is carried out following the first region.

### BACKGROUND OF THE INVENTION

1. Field of the Invention

The present invention relates to an information recording medium on which servo patterns, where recording regions and non-recording regions are disposed corresponding to servo data, are formed in servo pattern regions, and to a recording/reproducing apparatus equipped with such information recording medium.

2. Description of the Related Art

As one example of this type of information recording medium, Japanese Laid-Open Patent Publication No. 2006-40354 discloses a patterned disk medium (hereinafter simply “magnetic disk”) where servo pattern portions are physically formed by the presence or absence of magnetic bodies and a magnetic disk drive equipped with such magnetic disk. When manufacturing such magnetic disk, first a pattern lithography process, a developing process, an electroforming process, and the like are carried out in the mentioned order to fabricate a stamper, a mask to be used during an etching process is then formed by imprinting using such stamper, and then a preform for manufacturing a magnetic disk is etched.

More specifically, first a matrix (a substrate used to fabricate a stamper) on which a resist has been applied is set in an electron beam exposing apparatus and regions corresponding to non-magnetized parts of the magnetic disk (i.e., regions corresponding to concaves in a concave/convex pattern to be formed in a magnetic layer on a magnetic disk) are irradiated with an electron beam. By doing so, a concave forming pattern is drawn on the resist layer on the matrix. Next, the matrix for which the drawing of the concave forming pattern on the resist layer has been completed is subjected to a developing process to remove the resist layer at parts irradiated with the electron beam from the matrix. By doing so, the parts where the resist layer is removed become concaves, thereby forming a concave/convex pattern in the resist layer. After this, a concave/convex pattern is formed in the matrix by an etching process that uses the formed concave/convex pattern as a mask. After the formation of the concave/convex pattern is complete, the matrix is made electrically conductive, and then by carrying out an electroforming process, the concave/convex pattern of the matrix is transferred to an electroforming material (i.e., nickel). Next, the nickel layer is separated from the matrix and is punched out (cut out) into a predetermined shape to complete a disk-shaped nickel stamper.

After this, a preform for manufacturing a magnetic disk and the stamper that has been fabricated are set in an imprinting apparatus and the concave/convex pattern of the stamper is transferred to a resist layer formed on the preform. Next, an ion milling process is carried out on a magnetic layer of the preform with the resist to which the concave/convex pattern has been transferred as a mask (guard layer). At this time, the magnetic layer at parts exposed from the layer of resist used as the mask (i.e., at the base surfaces of the concaves in the concave/convex pattern) is removed, thereby forming a desired concave/convex pattern in the magnetic layer. Next, after the resist layer used as a mask has been removed, a non-magnetic material is sputtered. After this, the layer of the non-magnetic material is reverse-sputtered until the surface of the magnetic layer is exposed from the layer of non-magnetic material. By doing so, the surface of the magnetic disk is smoothed. After this, by carrying out a process that forms a DLC protective layer and a process that applies a lubricant, the magnetic disk is completed.

### SUMMARY OF THE INVENTION

On the other hand, by investigating the conventional magnetic disk described above, the present inventors found the following problem. More specifically, as shown in FIG. 23, on a conventional magnetic disk 10x, a servo pattern is formed in each servo pattern region Asx by plural convexes 25ax and plural concaves 25bx. In the preamble pattern region Apx in a servo pattern region Asx on the conventional magnetic disk 10x, plural convexes 25ax that have an equal length in the direction of rotation of the magnetic disk 10x (i.e., the direction of the arrow R1x) and are long in the radial direction of the magnetic disk 10x (i.e., the up-down direction in FIG. 23) are provided at a pitch Px with the concaves 25bx in between. Also, in a servo address mark region Amx of each servo pattern region Asx of the conventional magnetic disk 10x, convexes 25ax and concaves 25bx of a variety of shapes with different lengths in the direction of rotation and/or the radial direction of the magnetic disk 10x are provided.

On the other hand, to respond to demands for information recording media to be smaller and have a higher recording density, it is necessary on current magnetic disks to make the formation pitch in the direction of rotation (in the example described above, the pitch Px or the like) of the convexes 25ax and the concaves 25bx described above much smaller. Accordingly, when fabricating a stamper used to manufacture this type of magnetic disk, it is necessary to make the pitch in the direction of rotation of regions corresponding to the convexes 25ax and the concaves 25bx described above much smaller. For this reason, as shown in FIG. 24, the present inventors emitted an electron beam onto a resist layer on a matrix with a smaller pitch Pez corresponding to the formation pitch of the concaves to be formed in the preamble pattern regions of a magnetic disk (i.e., corresponding to the formation pitch of the convexes of a stamper to be fabricated) to draw a concave forming pattern Epz on the matrix. Hereinafter, component elements that relate to a magnetic disk and a stamper experimentally fabricated by the inventors when conceiving the present invention are indicated by appending “z” to the reference numerals.

In this case, as described earlier, when etching a matrix using a concave/convex pattern formed in a resist layer on the matrix as a mask, not only the matrix but also the resist layer used as the mask (that is, the convexes of the concave/convex pattern) will be etched. Accordingly, since the convexes in the concave/convex pattern used as the mask pattern become gradually narrower as the etching process progresses (that is, the length along the direction of rotation and/or the length along the radial direction become shorter), to form concaves of the desired width (i.e., concaves with openings of the desired size) in the matrix, it is necessary to make the width (length) of the convexes of the concave/convex pattern formed on the resist layer on the matrix quite wide (long). When, the drawing of the concave forming pattern Epz described above has been completed and, as described earlier, the parts irradiated with the electron beam have been removed from the matrix by a developing process to form a concave/convex pattern (mask pattern) on the matrix, if the width of the convexes in the concave/convex pattern is narrow (that is, if the length of the convexes in a direction corresponding to the direction of rotation of the magnetic disk is short), there will be the risk of damage or loss of the convexes during the period from the completion of the developing process to the formation of the concave/convex pattern in the matrix by the etching process, so that the convexes will not function sufficiently as a mask during the etching of the matrix. Accordingly, when drawing the concave forming pattern Epz described above during the manufacturing of a stamper for manufacturing this type of magnetic disk, it is necessary to set the length L4z of the regions irradiated with the electron beam (i.e., the length in the direction corresponding to the direction of rotation of the magnetic disk) sufficiently short to avoid a situation where the length along the direction of rotation of the convexes formed after the developing process become excessively short.

For this reason, when drawing the concave forming pattern Epz described above, as shown by the arrow Z1z in FIG. 24, the present inventors found that there is the risk that parts supposed to be irradiated with the electron beam corresponding to the concaves 25bz in a preamble pattern region Apz in a servo pattern region Asz on the magnetic disk 10z (see FIG. 25) will be insufficiently irradiated with the electron beam, resulting in the resist layer at such parts being insufficiently exposed. In this case, as shown in FIG. 25 the present inventors found that when a stamper is fabricated by forming a concave/convex pattern as a mask pattern by developing a concave forming pattern Epz in which insufficiently exposed parts are present, as shown by the arrow Z2z in FIGS. 25 and 26, in parts of the preamble pattern region Apz of the magnetic disk 10z manufactured by an imprinting process using this stamper, plural convexes 25az (the convexes 25az that are long in the radial direction) that are aligned at the pitch Pz become connected in the direction of rotation via another convex 25az.

Accordingly, when convexes with a sufficient length to function as a mask are formed while sufficiently reducing the pitch Pez at which the electron beam is irradiated during the manufacturing of a stamper, on a magnetic disk 10z manufactured using a stamper manufactured in accordance with this method, positions where the convexes 25az are continuous for the length L11z in the direction of rotation will be produced inside the preamble pattern region Apz. Here, as shown in FIG. 25, the length L1 along the direction of rotation (the direction of the arrow R1z) is equal for the convexes 25az inside the preamble pattern region Apz. On the other hand, for the convexes 25az inside a servo address mark region Amz, the length along the direction of rotation is not limited to L1z and can be various lengths, such as a length L3z that is double the length L1z and a length (not shown) that is triple the length L1z.

This means that on the magnetic disk 10z on which the convex parts 25az of the length L11z are formed inside the preamble pattern region Apz as described above, there is the risk that the convexes 25az of the length L11z will be erroneously detected as the convexes 25az of the length L3z, for example, inside the servo address mark region Amz, which makes it difficult to carry out tracking servo control correctly.

More specifically, for the magnetic disk 10z described above where the length along the direction of rotation of the convexes 25az inside the preamble pattern region Apz is the length L11z, during recording and reproducing there are cases where the control unit erroneously judges that a read of servo data from the servo address mark region Amz has started (that is, the read of the servo data from the preamble pattern region Apz has ended) based on the signal outputted from the magnetic head when a convex 25az of the length L11z has passed below the magnetic head due to rotation of the magnetic disk 10z. When such erroneous judgment occurs, even though the signal outputted from the magnetic head when the convexes 25az that are formed next to the convex 25az with the length L11z and are indicated by the arrows Z3z, Z4z passes below the magnetic head actually forms part of the preamble signal read from the preamble pattern region Apz, the signal will be erroneously identified as some of the servo address marks read from the servo address mark region Amz, resulting in a read error occurring for the servo data.

In this way, the present inventors found that if the formation pitch of the convexes 25az that construct the servo patterns in the servo pattern regions Asz (such as the preamble pattern inside the preamble pattern region Apz) is made sufficiently smaller when manufacturing a magnetic disk, there will be positions where the amount of irradiation with an electron beam (that is, the amount of exposure for the resist) is insufficient when drawing a concave forming pattern Epz during the fabrication of a stamper for manufacturing such magnetic disk, and as a result, convexes 25az that are supposed to be formed independently end up being connected in the direction of rotation. This means that when the recording density of a magnetic disk is increased, it becomes difficult to read the servo data from the servo pattern regions Asz, resulting in the problem that tracking servo control errors may occur.

The present invention was conceived in view of the problem described above and it is a principal object of the present invention to provide an information recording medium where the recording density can be increased while still ensuring that the servo data can be correctly read and a recording/reproducing apparatus equipped with such information recording apparatus.

To achieve the stated object, on an information recording medium according to the present invention, servo patterns, in which recording regions and non-recording regions are disposed corresponding to servo data, are formed in servo pattern regions, and the information recording medium includes: a first region where first recording regions that are long in a radial direction of the information recording medium are disposed at a predetermined pitch with first non-recording regions in between in a preamble pattern region provided in each servo pattern region; and a second recording region that connects the first recording regions that are adjacent in a direction of rotation of the information recording medium, the second recording region being provided in the first region, wherein a second non-recording region is provided at a position that is adjacent in the direction of rotation to the first region and where a read of the servo data is carried out following the first region, and a length of the second non-recording region is longer in the direction of rotation than a length in the direction of rotation of the first non-recording regions at corresponding same-pattern-radius positions.

In this specification, data read when a servo pattern region passes below a magnetic head during the recording or reproducing of data on an information recording medium (that is, data corresponding to recording regions and non-recording regions inside a servo pattern region) is all defined as “servo data”. The expression “recording regions” in the present specification refers to regions that are constructed so as to hold a recorded magnetic signal in a readable manner (that is, regions constructed so as to have the ability to hold a magnetic signal in a readable manner). Similarly, the expression “non-recording regions” in the present specification refers to regions that are constructed so that an ability thereof to hold a magnetic signal in a readable manner is lower than that of the recording regions, or regions constructed so as not to effectively have such ability. More specifically, the expression “non-recording regions” in the present specification refers to regions that emit a smaller magnetic field than the recording regions described above in a state where a magnetic signal has been recorded, or regions that effectively do not emit a magnetic field. In addition, the expression “first region” in the present specification refers to a region that is long in the radial direction and extends from a position of a first recording region at one end in the direction of rotation out of the first recording regions disposed at a predetermined pitch inside the preamble pattern region (for example, from a position of a first recording region at the end where the first servo data is read during a read of servo data from the preamble pattern region) to a position of a first recording region at the other end in the direction of rotation (for example, to a position of a first recording region at the end where the last servo data is read during a read of servo data from the preamble pattern region).

A recording/reproducing apparatus according to the present invention includes: the information recording medium described above; a magnetic head that reads the servo data from the servo pattern regions; and a control unit that carries out tracking servo control based on the read servo data.

For the information recording medium and the recording/reproducing apparatus described above, the second non-recording region is provided at a position that is adjacent in the direction of rotation to the first region on the information recording medium and where a read of the servo data is carried out following the first region. Therefore, according to this information recording medium and recording/reproducing apparatus, when manufacturing an information recording medium where the formation pitch of the recording regions inside the servo pattern regions is sufficiently reduced to increase the recording density, even if the irradiation amount of the beam used for lithography (an electron beam or the like) at a position corresponding to a first non-recording region inside the first region of the information recording medium is insufficient when drawing a concave forming pattern used to manufacture a stamper, resulting in a state where plural first recording regions inside the first region become connected via a second recording region, it will still be possible to avoid a situation where it is erroneously judged, based on the servo data read when a position where the first recording regions are connected via the second recording region (i.e., a position where the length in the direction of rotation of the recording regions that are continuous in the direction of rotation inside the first region is longer than the length in the direction of rotation of one first recording region) passes below the magnetic head, that a read of the preamble pattern from the preamble pattern region has ended.

Also, on the recording/reproducing apparatus according to the present invention, the control unit in the recording/reproducing apparatus described above judges that a read of preamble data in the servo data has ended when the servo data corresponding to the second non-recording region is read by the magnetic head. Therefore, according to this recording/reproducing apparatus, even when plural first recording regions become connected via a second recording region due to the formation pitch of the recording regions inside the preamble pattern region being sufficiently reduced to increase the recording density, it will still be possible to correctly read the various servo data from the servo pattern regions and as a result it will be possible to reliably avoid a situation where tracking servo control errors occur. Here, the expression “when the servo data corresponding to the second non-recording region is read” includes “when plural servo data including the servo data corresponding to the second non-recording region are read”. More specifically, the present invention includes a construction where it is judged, when the servo data corresponding to the second non-recording region and servo data corresponding to recording regions and non-recording regions that are formed so as to be aligned with the second non-recording region are read, that the read of the preamble data ends immediately preceding the time at which the servo data corresponding to the second non-recording region is read.

On the information recording medium according to the present invention, the second non-recording region may be provided at one of: a position where a read of the servo data in the preamble pattern region is carried out last; and a position that is adjacent in the direction of rotation to the preamble pattern region and where a read of the servo data is carried out following the servo data inside the preamble pattern region. Accordingly, unlike a construction where the second non-recording region is provided far from the preamble pattern region, there will be no recording regions or non-recording regions where servo data is recorded present between (i) the preamble pattern region where a second recording region that connects first recording regions is likely to occur during manufacturing and (ii) the second non-recording region. This means that it is possible to reliably read the servo data from the region in which the servo data is recorded following the region (i.e., the preamble pattern region) in which the recording regions and the non-recording regions for the preamble pattern are disposed.

In addition, on the information recording medium according to the present invention, the length in the direction of rotation of the second non-recording region may be equal to or longer than the predetermined pitch at same-pattern-radius positions. Therefore, according to this information recording medium, compared to an information recording medium where the length in the direction of rotation of: the second non-recording region is only slightly longer than the length in the direction of rotation of the first non-recording regions, the time required for the second non-recording region to pass below the magnetic head will be sufficiently long, and therefore it will be possible to reliably detect the signal when the second non-recording region passes below the magnetic head. In this way, according to this information recording medium, it is possible to reliably avoid a situation where it is erroneously judged, based on the servo data read when a position where the first recording regions are connected via a second recording region passes below the magnetic head, that a read of the preamble pattern from the preamble pattern region has ended.

In addition, on the information recording medium according to the present invention, the length in the direction of rotation of the second non-recording region may be a length that is N times the length in the direction of rotation of the first non-recording regions at corresponding same-pattern-radius positions, where N is a natural number of 2 or higher. Therefore, according to this information recording medium, unlike a construction where the length in the direction of rotation of the second non-recording region is set at a non-natural number multiple (such as 1.5 times) the length in the direction of rotation of the first non-recording regions used in the preamble pattern at same-pattern-radius positions, it will be possible to read the servo data from the entire servo pattern region without having to switch between plural reference clocks to read the servo data from the servo pattern region. By doing so, according to this information recording medium, it is possible not only to easily carry out tracking servo control but also to sufficiently lower the manufacturing cost of a recording/reproducing apparatus equipped with the information recording medium by an amount corresponding to it being no longer necessary to use control data of a complex data structure.

On the information recording medium according to the present invention, servo patterns, in which recording regions and non-recording regions are disposed corresponding to servo data, are formed in servo pattern regions, and the information recording medium includes: a second region where third non-recording regions that are long in a radial direction of the information recording medium are disposed at a predetermined pitch with third recording regions in between in a preamble pattern region provided in each servo pattern region; and a fourth non-recording region that connects the third non-recording regions that are adjacent in the direction of rotation of the information recording medium, the fourth non-recording region being provided in the second region, wherein a fourth recording region is provided at a position that is adjacent in the direction of rotation to the second region and where a read of the servo data is carried out following the second region, and a length in the direction of rotation of the fourth recording region is longer than a length in the direction of rotation of the third recording regions at corresponding same-pattern-radius positions.

In this case, the expression “second region” in the present specification refers to a region that is long in the radial direction and extends from a position of a third non-recording region at one end in the direction of rotation out of the third non-recording regions disposed at a predetermined pitch inside the preamble pattern region (for example, from a position of a third non-recording region at the end where the first servo data is read during a read of servo data from the preamble pattern region) to a position of a third non-recording region at the other end in the direction of rotation (for example, to a position of a third non-recording region at the end where the last servo data is read during a read of servo data from the preamble pattern region).

A recording/reproducing apparatus according to the present invention includes: the information recording medium described above; a magnetic head that reads the servo data from the servo pattern regions; and a control unit that carries out tracking servo control based on the read servo data.

For the information recording medium and the recording/reproducing apparatus described above, the fourth recording region is provided at a position that is adjacent in the direction of rotation to the second region on the information recording medium and where a read of the servo data is carried out following the second region. Therefore, according to this information recording medium and recording/reproducing apparatus, when manufacturing an information recording medium where the formation pitch of the non-recording regions inside the servo pattern regions is sufficiently reduced to increase the recording density, even if the irradiation amount of the beam used for lithography (an electron beam or the like) at a position corresponding to a third recording region inside the second region of the information recording medium is insufficient when drawing a concave forming pattern used to manufacture a stamper, resulting in a state where plural third non-recording regions inside the second region become connected via a fourth non-recording region, it will still be possible to avoid a situation where it is erroneously judged, based on the servo data read when a position where the third non-recording regions are connected via the fourth non-recording region (i.e., a position where the length in the direction of rotation of the non-recording regions that are continuous in the direction of rotation inside the second region is longer than the length in the direction of rotation of one third non-recording region) passes below the magnetic head, that a read of the preamble pattern from the preamble pattern region has ended.

Also, on the recording/reproducing apparatus according to the present invention, the control unit in the recording/reproducing apparatus described above judges that a read of preamble data in the servo data has ended when the servo data corresponding to the fourth recording region is read by the magnetic head. Therefore, according to this recording/reproducing apparatus, even when plural third non-recording regions become connected via a fourth non-recording region due to the formation pitch of the non-recording regions inside the preamble pattern region being sufficiently reduced to increase the recording density, it will still be possible to correctly read the various servo data from the servo pattern regions and as a result it will be possible to reliably avoid a situation where tracking servo control errors occur. Here, the expression “when the servo data corresponding to the fourth recording region is read” includes “when plural servo data including the servo data corresponding to the fourth non-recording region are read”. More specifically, the present invention includes a construction where it is judged, when the servo data corresponding to the fourth recording region and servo data corresponding to non-recording regions and recording regions that are formed so as to be aligned with the fourth recording region are read, that the read of the preamble data ends immediately preceding the time at which the servo data corresponding to the fourth recording region is read.

On the information recording medium according to the present invention, the fourth recording region may be provided at one of: a position where a read of the servo data in the preamble pattern region is carried out last; and a position that is adjacent in the direction of rotation to the preamble pattern region and where a read of the servo data is carried out following the servo data inside the preamble pattern region. Accordingly, unlike a construction where the fourth recording region is provided far from the preamble pattern region, there will be no recording regions or non-recording regions where servo data is recorded present between (i) the preamble pattern region where a fourth non-recording region that connects third non-recording regions is likely to occur during manufacturing and (ii) the fourth recording region. This means that it is possible to reliably read the servo data from the region in which the servo data is recorded following the region (i.e., the preamble pattern region) in which the recording regions and the non-recording regions for the preamble pattern are disposed.

In addition, on the information recording medium according to the present invention, a length in the direction of rotation of the fourth recording region may be equal to or longer than the predetermined pitch at same-pattern-radius positions.

Therefore, according to this information recording medium, compared to an information recording medium where the length in the direction of rotation of the fourth recording region is only slightly longer than the length in the direction of rotation of the third recording regions, the time required for the fourth recording region to pass below the magnetic head will be sufficiently long, and therefore it will be possible to reliably detect the signal when the fourth recording region passes below the magnetic head. In this way, according to this information recording medium, it is possible to reliably avoid a situation where it is erroneously judged, based on the servo data read when a position where the third non-recording regions are connected via a fourth non-recording region passes below the magnetic head, that a read of the preamble pattern from the preamble pattern region has ended.

In addition, on the information recording medium according to the present invention, a length in the direction of rotation of the fourth recording region may be a length that is N times the length in the direction of rotation of the third recording regions at corresponding same-pattern-radius positions, where N is a natural number of 2 or higher. Therefore, according to this information recording medium, unlike a construction where the length in the direction of rotation of the fourth recording region is set at a non-natural number multiple (such as 1.5 times) the length in the direction of rotation of the third recording regions used in the preamble pattern at same-pattern-radius positions, it will be possible to read the servo data from the entire servo pattern region without having to switch between plural reference clocks to read the servo data from the servo pattern region. By doing so, according to this information recording medium, it is possible not only to easily carry out tracking servo control but also to sufficiently lower the manufacturing cost of a recording/reproducing apparatus equipped with the information recording medium by an amount corresponding to it being no longer necessary to use control data of a complex data structure.

### BRIEF DESCRIPTION OF THE DRAWINGS

These and other objects and features of the present invention will be explained in more detail below with reference to the attached drawings, wherein:

FIG. 1 is a schematic diagram showing the construction of a hard disk drive according to the present invention;

FIG. 2 is a cross-sectional view of a magnetic disk according to the present invention;

FIG. 3 is a plan view of the magnetic disk according to the present invention;

FIG. 4 is a plan view of data track pattern regions and servo pattern regions on the magnetic disk according to the present invention;

FIG. 5 is a plan view of a servo pattern region on the magnetic disk according to the present invention;

FIG. 6 is a cross-sectional view of a matrix for manufacturing the magnetic disk according to the present invention;

FIG. 7 is a pattern diagram showing one example of a concave forming pattern for manufacturing a stamper for manufacturing the magnetic disk according to the present invention;

FIG. 8 is a cross-sectional view of the matrix in a state where drawing of the concave forming pattern on a B1 mask forming layer has been completed during the manufacturing of the stamper for manufacturing the magnetic disk according to the present invention;

FIG. 9 is a cross-sectional view of the matrix in a state after developing the B1 mask forming layer for which the drawing of the concave forming pattern has been completed during the manufacturing of the stamper for manufacturing the magnetic disk according to the present invention;

FIG. 10 is a cross-sectional view of the matrix in a state where etching has been carried out on an A1 mask forming layer with the B1 mask forming layer as a mask during the manufacturing of the stamper for manufacturing the magnetic disk according to the present invention;

FIG. 11 is a cross-sectional view of the matrix in a state where etching has been carried out on a silicon substrate using the A1 mask forming layer as a mask during the manufacturing of the stamper for manufacturing the magnetic disk according to the present invention;

FIG. 12 is a cross-sectional view of the silicon substrate in a state where a nickel layer has been formed so as to cover a concave/convex pattern during the manufacturing of the stamper for manufacturing the magnetic disk according to the present invention;

FIG. 13 is a cross-sectional view of the silicon substrate in a state where a nickel layer has been formed by electroforming using the nickel layer as an electrode during the manufacturing of the stamper for manufacturing the magnetic disk according to the present invention;

FIG. 14 is a cross-sectional view of a master stamper for manufacturing a magnetic disk according to the present invention;

FIG. 15 is a cross-sectional view of a stamper in a state where a mother stamper has been fabricated by transferring a concave/convex pattern of a master stamper to both stamper forming materials and removing the master stamper from the stamper forming materials during the manufacturing of the stamper for manufacturing the magnetic disk according to the present invention;

FIG. 16 is a cross-sectional view of both stampers in a state where a child stamper has been fabricated by injection molding using the mother stamper during the manufacturing of a stamper for manufacturing the magnetic disk according to the present invention;

FIG. 17 is a cross-sectional view of a child stamper and a preform for manufacturing the magnetic disk according to the present invention;

FIG. 18 is a cross-sectional view of a state where a child stamper has been removed from a B2 mask forming layer of the preform for which the imprinting process has been completed during manufacturing of the magnetic disk according to the present invention;

FIG. 19 is a cross-sectional view of a state where an A2 mask forming layer has been etched using the B2 mask forming layer formed by the imprinting process as a mask during manufacturing of the magnetic disk according to the present invention;

FIG. 20 is a cross-sectional view of a state where a magnetic layer is etched using the A2 mask forming layer in which a concave/convex pattern has been formed as a mask during manufacturing of the magnetic disk according to the present invention;

FIG. 21 is a plan view of a servo pattern region on another magnetic disk according to the present invention;

FIG. 22 is a plan view of yet another magnetic disk according to the present invention;

FIG. 23 is a plan view of a servo pattern region on a conventional magnetic disk;

FIG. 24 is a plan view of one example of a concave forming pattern drawn when the present inventors manufactured a magnetic disk;

FIG. 25 is a plan view of a servo pattern region on a magnetic disk manufactured by the present inventors; and

FIG. 26 is a plan view of a preamble pattern region in a servo pattern region on a magnetic disk manufactured by the present inventors.

### DESCRIPTION OF THE PREFERRED EMBODIMENTS

Preferred embodiments of an information recording medium and a recording/reproducing apparatus according to the present invention will now be described with reference to the attached drawings.

First, the construction of a recording/reproducing apparatus according to the present invention will be described with reference to the drawings.

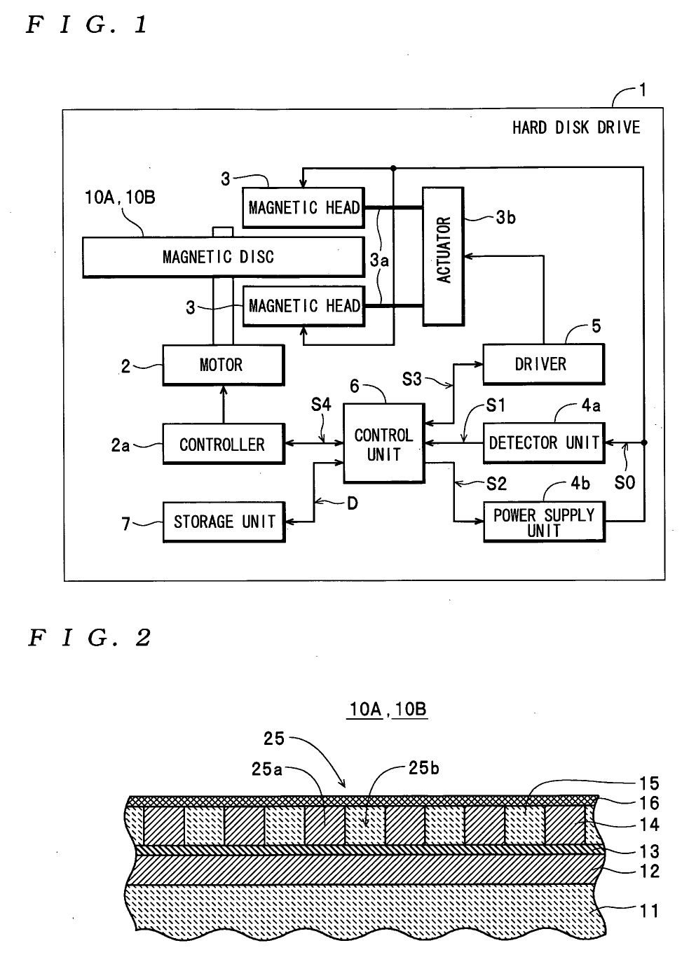

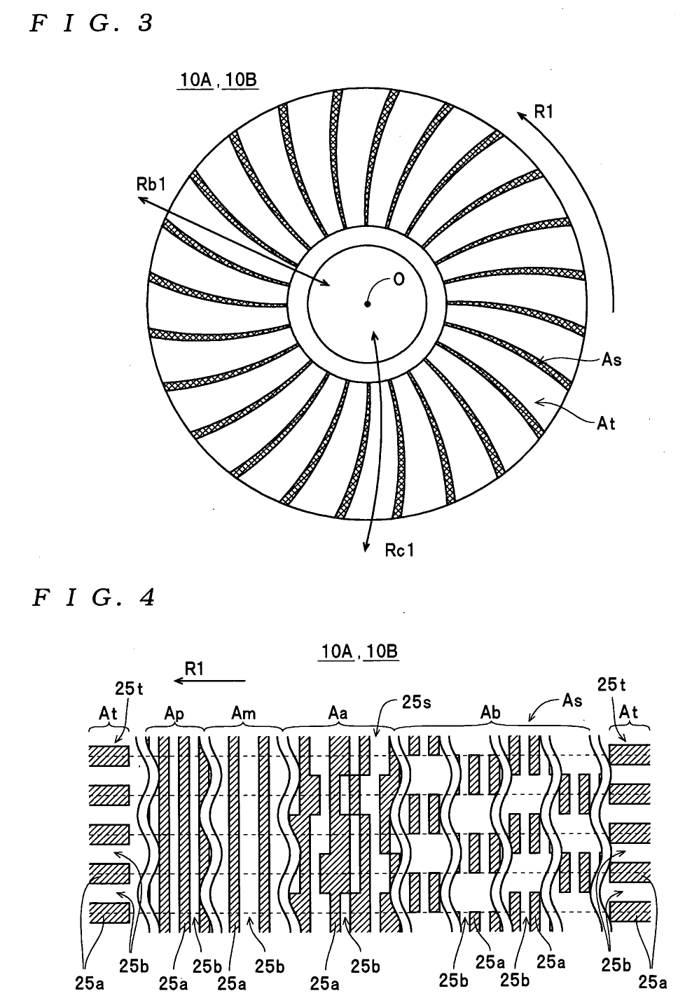

A hard disk drive 1 shown in FIG. 1 is one example of a “recording/reproducing apparatus” according to the present invention and includes a motor 2, a controller 2a, a pair of magnetic heads 3, a detector unit 4a, a power supply unit 4b, a driver 5, a control unit 6, a storage unit 7, and a magnetic disk 10A. The hard disk drive 1 is constructed so as to be capable of recording and reproducing various types of data. Note that although the hard disk drive 1 is equipped in reality with plural magnetic disks 10A and a pair of magnetic heads 3 for each magnetic disk 10A, for ease of understanding the present invention, a drive equipped with a single magnetic disk 10A and one pair of magnetic heads 3 for carrying out the recording and reproducing of data on such magnetic disk 10A is described below. In this case, the magnetic disk 10A is a double-sided recordable discrete track medium (one example of a “patterned medium”) that is one example of an “information recording medium” according to the present invention, is formed in an overall circular plate shape as shown in FIG. 3, and is attached to a rotation shaft of the motor 2.

The motor 2 rotates the magnetic disk 10A at a constant velocity, for example 4200 rpm, in accordance with control by the control unit 6. The controller 2a rotates the motor 2 in accordance with a control signal S4 outputted from the control unit 6. Out of the magnetic heads 3, one magnetic head 3 is disposed facing one surface (the upper surface in FIG. 1) of the magnetic disk 10A and is attached to an actuator 3b via a swing arm 3a and the other magnetic head 3 is disposed facing the other surface (the lower surface in FIG. 1) of the magnetic disk 10A and is attached to the actuator 3b via a swing arm 3a. Here, both magnetic heads 3 are moved over the magnetic disk 10A by rotating the swing arms 3a using the actuator 3b during the recording and reproducing of data on the magnetic disk 10A. The magnetic heads 3 carry out reads of servo signals from servo pattern regions As (see FIGS. 3 and 4) of the magnetic disk 10A, magnetic writes of data in data track pattern regions At (see FIGS. 3 and 4), and reads of data that has been magnetically written in the data track pattern regions At.

Note that although the magnetic heads 3 are each actually constructed by forming a recording element and a reproducing element on the base surface (i.e., air bearing surface) of a slider for causing the magnetic head 3 to fly above the magnetic disk 10A, the sliders, the recording elements, the reproducing elements, and the like are omitted from the description and drawings. According to a driving current supplied from the driver 5 under the control of the control unit 6, the actuator 3b swings the swing arms 3a to move the magnetic heads 3 to a freely chosen recording/reproducing position above the magnetic disk 10A. The detector unit 4a extracts servo data from an output signal S0 (analog signal: servo signal) outputted from the magnetic heads 3 to generate a detection signal S1, and outputs the generated detection signal S1 to the control unit 6. During the recording of data on the magnetic disk 10A, the power supply unit 4b supplies an AC voltage whose potential is reversed at predetermined periods to the magnetic heads 3 in accordance with a control signal S2 outputted from the control unit 6. The driver 5 controls the actuator 3b in accordance with a control signal S3 outputted from the control unit 6 to make the magnetic heads 3 on-track to desired data recording tracks.

The control unit 6 is one example of a “control unit” for the present invention and carries out overall control over the hard disk drive 1. Also, based on the detection signal (servo data) S1 outputted from the detector unit 4a and control data D stored in the storage unit 7, the control unit 6 controls the controller 2a, the power supply unit 4b, and the driver 5 (i.e., the control unit 6 carries out a tracking servo control process and a recording/reproducing process for data). The storage unit 7 stores the control data D mentioned above and the like.

On the other hand, the magnetic disk 10A is installed inside the case of the hard disk drive 1 together with the motor 2, the magnetic heads 3, and the like. As shown in FIG. 2, the magnetic disk 10A is constructed by forming a soft magnetic layer 12, an intermediate layer 13, and a magnetic layer 14 in the mentioned order on both surfaces of a glass substrate 11. As one example, data can be recorded on the magnetic disk 10A using a perpendicular recording method. Note that in FIG. 2, only one surface of the glass substrate 11 is shown. Here, as one example, each magnetic layer 14 constructs a concave/convex pattern 25 where plural convexes 25a that are formed from base end portions to protruding end portions thereof of magnetic material and concaves 25b disposed between adjacent convexes 25a are formed. Also, non-magnetic material 15 such as SiO₂, C (carbon), Si, Ge, a non-magnetic metal material, and resin material is filled in the concaves 25b of the respective concave/convex patterns 25 to smooth the surfaces of the magnetic disk 10A.

In this case, on the magnetic disk 10A, formation regions of the convexes 25a correspond to “recording regions” for the present invention and formation regions of the concaves 25b correspond to “non-recording regions” for the present invention. In addition, on the magnetic disk 10A, a protective layer 16 (a DLC film) with a thickness of around 4 nm is formed of diamond-like carbon (DLC) or the like so as to cover the surface of the non-magnetic material 15 filled in the concaves 25b (i.e., filled between the adjacent convexes 25a) and the surface of the magnetic layer 14 (the convexes 25a) on both surfaces of the magnetic disk 10A. A lubricant is also applied onto the surfaces of both protective layers 16 to prevent damage to both the magnetic heads 3 and the magnetic disk 10A.

The glass substrate 11 is formed in a circular plate shape with a thickness of around 0.6 mm by polishing the surface of a glass plate, for example. Note that the base plate used when forming the magnetic disk 10A is not limited to a glass substrate and it is possible to use a base plate formed in a circular plate shape using various types of non-magnetic material such as aluminum and ceramics. On each surface, the soft magnetic layer 12 is formed in a thin film shape with a thickness of around 20 nm to 200 nm, inclusive by sputtering a soft magnetic material such as CoZrNb alloy. The intermediate layer 13 functions as an underlayer for forming the magnetic layer 14 and is formed in a thin film shape with a thickness of around 5 nm to 40 nm by sputtering an intermediate layer forming material such as Ru, Cr or a non-magnetic CoCr alloy. As described earlier, the magnetic layer 14 is a layer that constructs the concave/convex pattern 25 (the data track patterns 25t and the servo patterns 25s shown in FIG. 4) and the concaves 25b are formed by etching a layer produced by sputtering CoCrPt alloy, for example.

As shown in FIGS. 3 and 4, on both surfaces of the magnetic disk 10A, the servo pattern regions As are provided between the data track pattern regions At and are defined so that the data track pattern regions At and the servo pattern regions As are alternately disposed in the direction of rotation of the magnetic disk 10A (i.e., the direction of the arrow R1). Note that in the present specification, each region sandwiched by two data track pattern regions At aligned in the direction of rotation (i.e., each region from a trailing end in the direction of rotation of a data track pattern region At to a leading end in the direction of rotation of the next data track pattern region At) is regarded as a servo pattern region As. Also, the ends in the direction of rotation of the data track pattern regions At are set as coinciding with virtual segments (linear or arc-shaped segments along the radial direction of the magnetic disk 10A) that join the respective ends in the direction of rotation of plural data recording tracks (the convexes 25a) formed in the data track pattern regions At.

The hard disk drive 1 equipped with the magnetic disk 10A is constructed so that the magnetic disk 10A is rotated at a fixed angular velocity by the motor 2 in accordance with control by the control unit 6 as described earlier. Accordingly, as shown in FIG. 3, on the magnetic disk 10A, the length of each data track pattern region At along the direction of rotation of the magnetic disk 10A and the length of each servo pattern region As along the direction of rotation are set so as to increase as the distance from the center O of the data track patterns 20t increases (i.e., the data track pattern regions At and the servo pattern regions As are set so as to widen from an inner periphery region toward an outer periphery region) in proportion to the length of a part of the magnetic disk 10A that passes below the magnetic head 3 per unit time. As a result, the length along the direction of rotation of the protruding end surfaces of the data recording tracks (the convexes 25a) formed inside the data track pattern regions At, the standard length along the direction of rotation of the protruding end surfaces of the convexes 25a used in the servo patterns 25s formed inside the servo pattern regions As, and the standard gap length (i.e., the length of a gap between facing ends of the protruding end surfaces of two adjacent convexes 25a: for example a length corresponding to the unitary signal length) along the direction of rotation of the concaves 25b used in the servo patterns 25s are set so as to increase from the inner periphery region to the outer periphery region of the magnetic disk 10A.

Also, as shown in FIG. 4, a data track pattern 25t is formed in each data track pattern region At. Note that the obliquely shaded regions in FIG. 4 show formation positions of the convexes 25a (“recording regions” for the present invention) in the concave/convex pattern 25. In this example, the data track patterns 25t inside the data track pattern regions At are composed of plural convexes 25a (belt-shaped convexes 25a that are long and continuously 35 formed in the direction of rotation of the magnetic disk 10A) that construct a large number of data recording tracks that are concentric (or spiral) and are disposed a predetermined pitch apart, and plural concaves 25b (the concaves 25b between the convexes 25a: inter-track concaves) that construct guard band parts. Also, the convexes 25a and the concaves 25b inside the data track pattern regions At are set so that the formation pitch thereof (that is, the track pitch of the data recording tracks) and the length thereof in the radial direction of the magnetic disk 10A (that is, the lengths in the radial direction of the data recording tracks and the guard band parts) are substantially equal across the entire range from the inner periphery to the outer periphery of the magnetic disk 10A.

On the other hand, in each servo pattern region As, plural regions are aligned in the direction of rotation, and concave/convex patterns 25 (the servo patterns 25s) with plural convexes 25a and plural concaves 25b that construct various servo patterns for tracking servo control are formed inside such regions. More specifically, as shown in FIG. 4, a preamble pattern region Ap in which a preamble pattern is formed by the servo pattern 25s, a servo address mark region Am in which servo address marks (i.e., a servo address mark pattern) are formed by the servo pattern 25s, an address pattern region Aa in which an address pattern is formed by the servo pattern 25s, and a burst pattern region Ab in which burst patterns are formed by the servo pattern 25s are defined in the mentioned order in the direction of rotation inside each servo pattern region As. Note that although in reality the convexes 25a and the concaves 25b are given skew angles in the servo pattern 25s described above in the inner periphery region and the outer periphery region of the magnetic disk 10A, for ease of understanding the present invention, the skew angles have been omitted from the description and drawings.

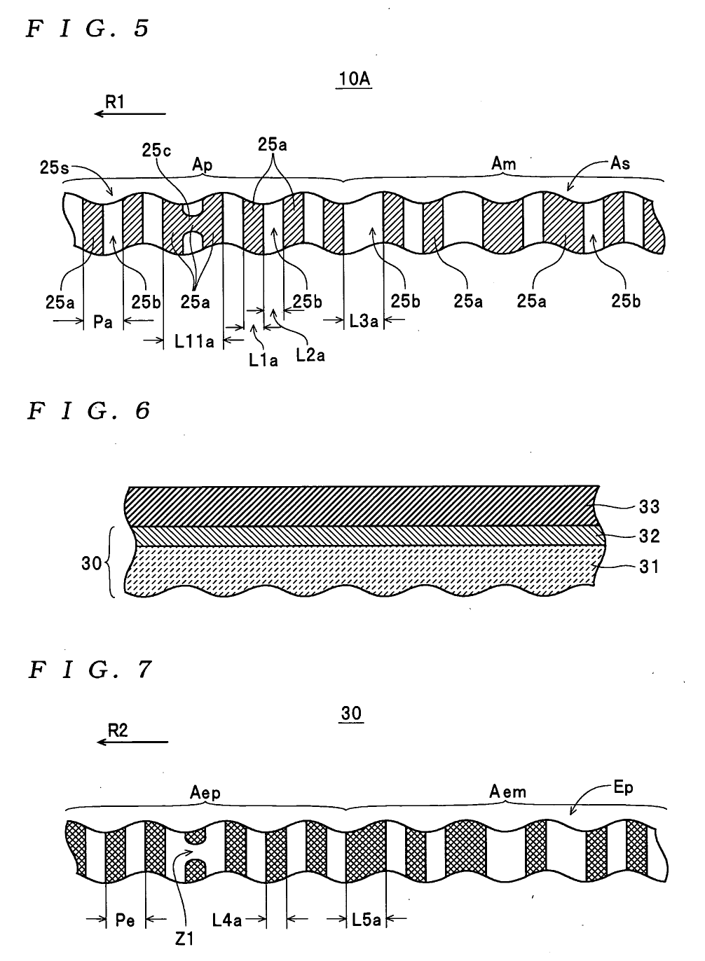

In the preamble pattern region Ap, preamble patterns for correcting a reference clock for reading a variety of control signals from the servo address mark region Am, the address pattern region Aa, and the like in accordance with a rotational state (i.e., the rotational velocity) of the magnetic disk 10A and for adjusting the gain of the output of the servo data and user data (i.e., data recorded on data recording tracks) are formed. In this case, on the magnetic disk 10A, the entire preamble pattern region Ap constructs a “first region” for the present invention and the convexes 25a and the concaves 25b are alternately disposed in accordance with a preamble signal as servo data between a leading end and a trailing end of the preamble pattern region Ap in the direction of rotation. More specifically, as shown in FIGS. 4 and 5, in the preamble pattern region Ap, plural belt-shaped convexes 25a (one example of “first recording regions” for the present invention) that are long in the radial direction of the magnetic disk 10A (the up-down direction in both drawings: the direction of the arrow Rb1 shown in FIG. 3) are disposed at a pitch Pa (one example of a “predetermined pitch” for the present invention) with the concaves 25b (one example of “first non-recording regions” for the present invention) in between. Note that the convexes 25a (“first recording regions” for the present invention) described above inside the preamble pattern region Ap are formed in reality of belt-like shapes (one example of a state that is “long in the radial direction” for the present invention) that are long along arc-shaped paths (the arc-shaped line shown by the arrow Rc1 in FIG. 3) traced when the magnetic head 3 described above moves between the inner periphery and the outer periphery of the magnetic disk 10A.

In this case, as shown in FIG. 5, in the servo pattern 25s inside the preamble pattern region Ap that constructs the preamble pattern, as one example, at a position where the distance from the center O (see FIG. 3) of the data track patterns 25t is 15 mm (one example of a “pattern-radius position” for the present invention), the pitch Pa (the “predetermined pitch” for the present invention) in the direction of rotation of the convexes 25a is set at 110 nm, the length L1a along the direction of rotation of the convexes 25a is set at 55 nm corresponding to the servo data “1”, and the length L2a along the direction of rotation of the concaves 25b is set at 55 nm corresponding to the servo data “0”. Note that the pitch Pa described above of the convexes 25a formed in the preamble pattern region Ap is set so as to be equal at “same-pattern-radius positions” (i.e., positions where the distance from the center O of the data track patterns 25t is equal) and so as to increase from the inner periphery region of the magnetic disk 10A to the outer periphery region of the magnetic disk 10A. In addition, the length L1a described above of the convexes 25a formed in the preamble pattern region Ap is set so as to be equal at same-pattern-radius positions where the distance from the center O of the data track patterns 25t is equal and so as to increase from the inner periphery region of the magnetic disk 10A to the outer periphery region of the magnetic disk 10A. In the same way, the length L2a described above of the concaves 25b formed in the preamble pattern region Ap is set so as to be equal at same-pattern-radius positions where the distance from the center O of the data track patterns 25t is equal and so as to increase from the inner periphery region of the magnetic disk 10A to the outer periphery region of the magnetic disk 10A.

On the magnetic disk 10A, the convexes 25a of the length L1a and the concaves 25b of the length L2a described above are formed so as to be alternately disposed up to a servo address mark region Am end of the preamble pattern region Ap, and a convex 25a of the length L1a described above that corresponds to a “first recording region” for the present invention is formed at the servo address mark region Am end of the preamble pattern region Ap. In addition, on the magnetic disk 10A, the convexes 25a inside the preamble pattern region Ap are formed as described above at the extremely narrow pitch Pa. This means that for the magnetic disk 10A, as described later, during manufacturing, at some positions inside the preamble pattern region Ap, a connecting portion 25c is formed by a convex 25a (one example of a “second recording region” for the present invention) so that convexes 25a that are adjacent in the direction of rotation become connected in the direction of rotation. In this case, as described above, since the length L1a of the convexes 25a at a position where the distance from the center O of the data track patterns 25t is 15 mm is 55 nm and the length L2a of the concaves 25b is 55 nm, when the connecting portion 25c described above is formed at a position where the distance from the center O is 15 mm, the length L11a where convexes 25a are continuous along the direction of rotation is 165 nm.

Servo address marks for specifying a read start position of an address pattern is formed in the servo address mark region Am. Also, the magnetic disk 10A uses a construction where a concave 25b that corresponds to a “second non-recording region” for the present invention is formed at a front region of the servo address mark region Am (i.e., the preamble pattern region Ap end in the direction of rotation: one example of a “position where a read of servo data is carried out following the servo data inside the preamble pattern region” for the present invention), with such concave 25b being used to identify the end of a read of a preamble pattern from the preamble pattern region Ap. In this case, as one example, the length L3a of the concave 25b that corresponds to the “second non-recording region” for the present invention at a position where the distance from the center O of the data track patterns 25t is 15 mm is set at 110 nm that is equal to the pitch Pa described above and twice the length L2a of the concaves 25b inside the preamble pattern region Ap described above (one example where “N times” for the present invention is “twice”).

As shown in FIG. 4, an address pattern corresponding to address data showing the track number of the track to which the magnetic head 3 is being made on-track and the sector number of the sector at which the magnetic head 3 is positioned is formed in the address pattern region Aa by the concave/convex pattern 25 including the convexes 25a and the concaves 25b. Burst patterns (i.e., servo patterns for position detection) for producing burst signals for correcting the position of a magnetic head 3 above the magnetic disk 10A are formed in each burst pattern region Ab by the concave/convex pattern 25 including the convexes 25a and the concaves 25b.

Next, a method of manufacturing the magnetic disk 10A will be described with reference to the drawings.

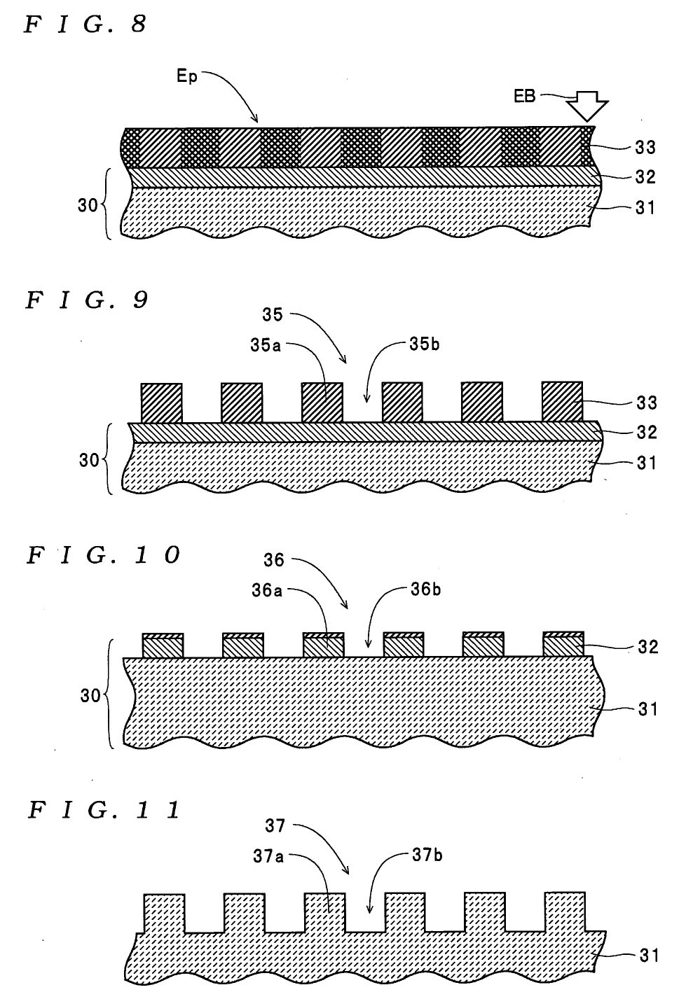

When manufacturing the magnetic disk 10A described above, first a stamper 60 (see FIG. 17) used during imprinting is manufactured. More specifically, as shown in FIG. 6, first, as one example, by sputtering nickel onto one surface of a silicon substrate 31, an A1 mask forming layer 32 with a thickness of 7 nm is formed to fabricate a matrix 30. After this, by spin coating an electron beam lithography resist (a positive-type resist) so that the thickness after baking is around 60 nm, a B1 mask forming layer (a resin layer: resist layer) 33 is formed on the A1 mask forming layer 32 (i.e., on the matrix 30), and the formed B1 mask forming layer 33 is then baked. Next, the matrix 30 is set in a pattern lithography apparatus (not shown) with the surface on which the B1 mask forming layer 33 has been formed facing upward and, as shown in FIG. 8, by emitting an electron beam EB onto the B1 mask forming layer 33 while rotating the matrix 30, a concave forming pattern Ep (see FIG. 7) is drawn on the B1 mask forming layer 33.

Note that the arrow R2 shown in FIG. 7 shows the direction of rotation of the matrix 30 during the drawing of the concave forming pattern Ep, which also corresponds to the direction of rotation of the magnetic disk 10A. In this case, the concave forming pattern Ep described above is a plan-view pattern of the convexes 45a in a concave/convex pattern 45 of a stamper 40 as a master stamper shown in FIG. 14 and is a plan-view pattern corresponding to the concaves 25b of the data track patterns and the concaves 25b in the servo patterns on the magnetic disk 10A described above. Also, as shown in FIG. 7, when the concave forming pattern Ep is drawn on the B1 mask forming layer 33, in each pattern lithography region Aep corresponding to a preamble pattern region Ap on the magnetic disk 10A, the electron beam EB is emitted with a length L4a along the direction of rotation (the direction of the arrow R2) of regions that will be sufficiently irradiated with the electron beam EB so that the resist layer will be eliminated during a developing process (described later) set corresponding to the concaves 25b of the length L2a that construct the preamble patterns and the pitch Pe set corresponding to the pitch Pa described above on the magnetic disk 10A.

Here, when drawing the concave forming pattern Ep for manufacturing the magnetic disk 10A or the like, as described earlier, it is necessary to set the length L4a of the regions irradiated with the electron beam EB sufficiently short to avoid a situation where the length along the direction of rotation of the convexes formed on the B1 mask forming layer 33 after the developing process is excessively short. This means that as shown by the arrow Z1 in FIG. 7, this can lead to a situation where irradiation with the electron beam EB is insufficient at positions that are supposed to be irradiated with the electron beam corresponding to the concaves 25b of the preamble pattern region Ap of the servo pattern regions As, which results in the B1 mask forming layer 33 being insufficiently exposed at such positions. Note that the present inventors found that when the pitch Pe described above is 150 nm or below, as shown by the arrow Z1, positions that are insufficiently exposed are produced in the B1 mask forming layer 33 inside the pattern lithography region Aep. On the other hand, at a position adjacent to the pattern lithography region Aep described above in a pattern lithography region Aem corresponding to each servo address mark region Am of the magnetic disk 10A, the electron beam EB is emitted with a length L5a along the direction of rotation of regions that will be sufficiently irradiated by the electron beam EB so that the resist layer will be eliminated during the developing process set corresponding to the concaves 25b of the length L3a that construct the servo address marks.

Next, the developing process is carried out on the B1 mask forming layer 33 for which the drawing of the concave forming pattern Ep has been completed. By doing so, the B1 mask forming layer 33 is removed from above the A1 mask forming layer 32 in elimination regions where the amount of irradiation with the electron beam EB reached a resist-layer-elimination level during the lithography process of the concave forming pattern Ep by the pattern lithography apparatus, and as shown in FIG. 9, concaves 35b are formed in such elimination regions, thereby forming a concave/convex pattern 35 on the A1 mask forming layer 32 (the matrix 30). In this case, even though positions (such as the position shown by the arrow Z1 in FIG. 7) inside the pattern lithography region Aep corresponding to the preamble pattern region Ap of the magnetic disk 10A where irradiation with the electron beam EB was insufficient during the drawing of the concave forming pattern Ep described above should be eliminated from above the A1 mask forming layer 32 during the developing process, such positions will remain on the A1 mask forming layer 32 (not shown). Accordingly, convexes 35a end up being formed at positions where the irradiation with the electron beam EB is insufficient (that is, at positions where concaves 35b should be formed). Next, after a rinsing process has been carried out on the matrix 30 for which the developing process has been completed, a spin drying process is carried out.

After this, by carrying out an etching process using the B1 mask forming layer 33 (i.e., the convexes 35a of the concave/convex pattern 35) for which the drying process has been completed as a mask, the A1 mask forming layer 32 that is exposed from the B1 mask forming layer 33 is removed from above the silicon substrate 31 at the base surfaces of the concaves 35b. By doing so, as shown in FIG. 10, concaves 36b are formed in the A1 mask forming layer 32 to form a concave/convex pattern 36 on the silicon substrate 31. Next, by carrying out an etching process using the A1 mask forming layer 32 (convexes 36a of the concave/convex pattern 36) as a mask, parts of the A1 mask forming layer 32 side of the silicon substrate 31 exposed from the A1 mask forming layer 32 at the base surfaces of the concaves 36b are removed. By doing so, as shown in FIG. 11, concaves 37b are formed in the silicon substrate 31 to form a concave/convex pattern 37 in the silicon substrate 31. Note that FIG. 11 shows a state where the A1 mask forming layer 32 remaining on the silicon substrate 31 (i.e., on convexes 37a of the concave/convex pattern 37) has been removed after completion of the etching process.

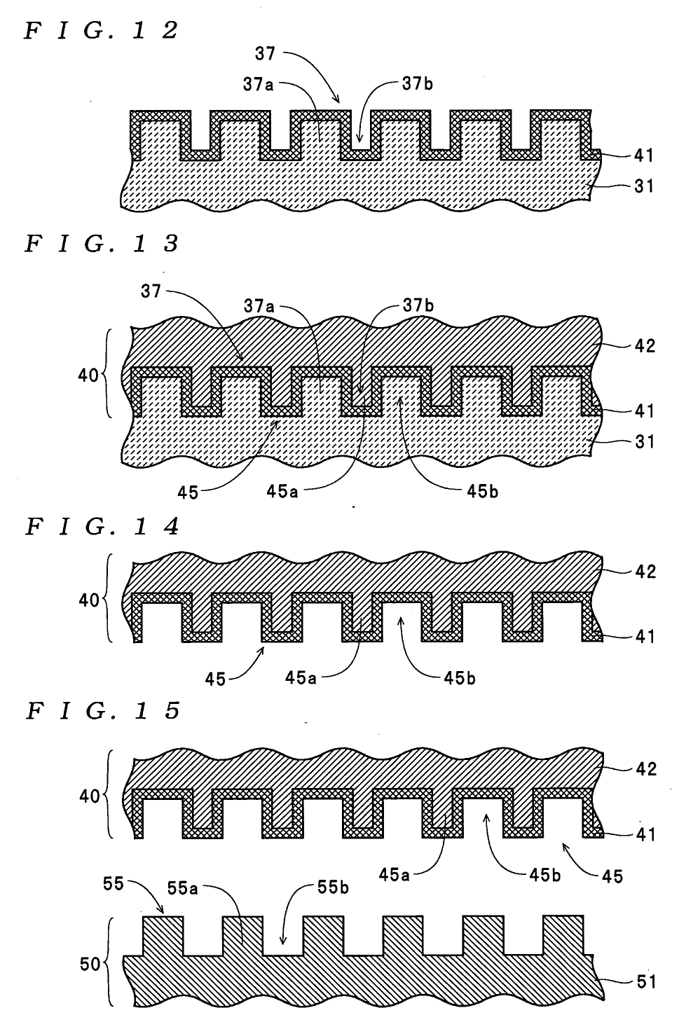

Next, after a nickel layer (conductive layer) 41 has been formed by a vapor deposition process, for example, on the surface of the concave/convex pattern 37 as shown in FIG. 12, a nickel layer 42 is formed by carrying out an electroplating process (an electroforming process) using the nickel layer 41 as an electrode as shown in FIG. 13. At this time, the concave/convex pattern 37 formed on the silicon substrate 31 is transferred to the nickel that constructs the nickel layers 41, 42 to form plural convexes 45a corresponding to the regions irradiated with the electron beam EB in the concave forming pattern Ep described above. Next, by separating the multilayer structure composed of the nickel layers 41, 22 from the silicon substrate 31, the stamper 40 as a master stamper is completed as shown in FIG. 14. Note that although it is possible to manufacture the magnetic disk 10A by carrying out an imprinting process using this stamper 40, there is the risk that the manufacturing cost of the magnetic disk 10A will rise due to the use of such high-cost stamper 40. Accordingly, by transferring the concave/convex pattern 45 of the stamper 40 to another stamper forming material according to the procedure described below, plural stampers are fabricated from the single stamper 40.

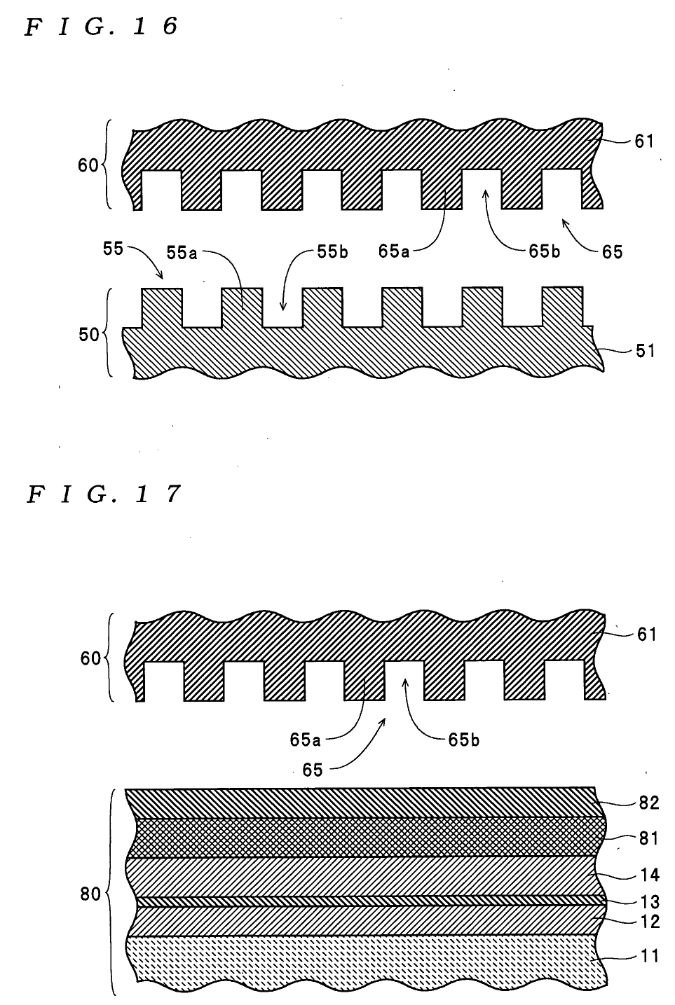

More specifically, as one example, a nickel layer 51 (see FIG. 15) is formed by carrying out an electroplating process (electroforming process) using the stamper 40 as an electrode. When doing so, the concave/convex pattern 45 of the stamper 40 is transferred to a metal material (in this example, nickel) to form plural convexes 55a corresponding to the concaves 45b of the concave/convex pattern 45 and plural concaves 55b corresponding to the convexes 45a of the concave/convex pattern 45. Next, by separating the nickel layer 51 from the stamper 40, as shown in FIG. 15, a stamper 50 as a mother stamper is completed. After this, an injection molding process is carried out using the stamper 50. When doing so, a concave/convex pattern 55 of the stamper 50 is transferred to a resin material 61 (see FIG. 16) to form plural convexes 65a corresponding to the concaves 55b of the concave/convex pattern 55 and plural concaves 65b corresponding to the convexes 55a of the concave/convex pattern 55. Next, by separating the resin material 61 from the stamper 50, as shown in FIG. 16, a stamper 60 as a child stamper is completed. In this way, by fabricating plural stampers 60 from a single stamper 50, it is possible to sufficiently reduce the manufacturing cost of the magnetic disk 10A manufactured using the stampers 60.

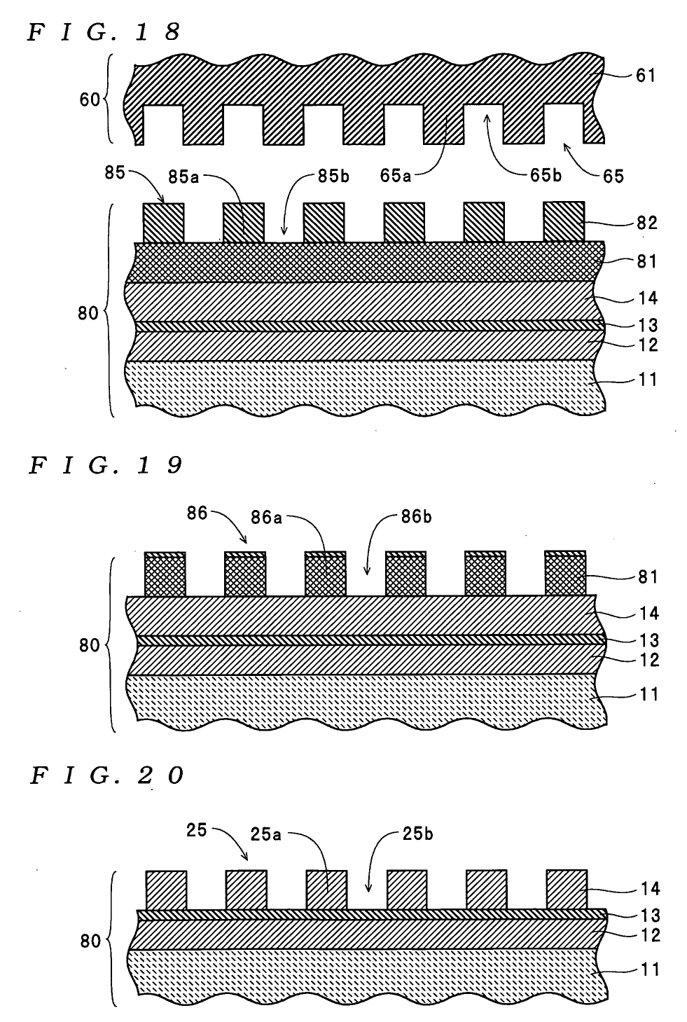

Next, the magnetic disk 10A is manufactured using the manufactured stamper 60. When doing so, as one example, first a preform 80 (see FIG. 17) for manufacturing the magnetic disk 10A and the stamper 60 are set in an imprinting apparatus. When doing so, as shown in FIG. 17, as one example the preform 80 has the soft magnetic layer 12, the intermediate layer 13, and the magnetic layer 14 formed in the mentioned order on the glass substrate 11, and an A2 mask forming layer 81 (as one example, a metal mask layer) and a B2 mask forming layer 82 (as one example, a resin mask layer) formed in the mentioned order so as to cover the magnetic layer 14. Next, after a concave/convex pattern 65 of the stamper 60 has been pressed onto the B2 mask forming layer 82 of the preform 80 to transfer the concave/convex pattern 65 to the B2 mask forming layer 82 (i.e., after imprinting is carried out), as shown in FIG. 18, the stamper 60 is separated from the preform 80. When doing so, plural concaves 85b are formed in the B2 mask forming layer 82 of the preform 80 corresponding to the convexes 65a of the concave/convex pattern 65 of the stamper 60 and plural convexes 85a are formed in the B2 mask forming layer 82 corresponding to the concaves 65b of the concave/convex pattern 65 to form a concave/convex pattern 85 as a resin mask pattern on the A2 mask forming layer 81.

Next, after the resin material remaining at the base surfaces of the concaves 85b of the concave/convex pattern 85 transferred to the B2 mask forming layer 82 has been removed by an etching process, another etching process is carried out on the A2 mask forming layer 81 using the concave/convex pattern 85 as a mask. By doing so, as shown in FIG. 19, a concave/convex pattern 86 including plural convexes 86a corresponding to the convexes 85a of the concave/convex pattern 85 transferred to the B2 mask forming layer 82 and plural concaves 86b corresponding to the concaves 85b of the concave/convex pattern 85 is formed in the A2 mask forming layer 81. After this, an etching process is carried out on the magnetic layer 14 using the concave/convex pattern 86 as a mask. By doing so, as shown in FIG. 20, the concave/convex pattern 25 including plural convexes 25a corresponding to the convexes 86a of the concave/convex pattern 86 formed in the A2 mask forming layer 81 and plural concaves 25b corresponding to the concaves 86b of the concave/convex pattern 86 is formed in the magnetic layer 14. Note that FIG. 20 shows a state where the A2 mask forming layer 81 remaining on the magnetic layer 14 (i.e., remaining on the convexes 25a of the concave/convex pattern 25) has been removed after the completion of the etching process.

Next, after the non-magnetic material 15 has been formed with sufficient thickness so as to cover the concave/convex pattern 25, an etching process is carried out on the layer of the non-magnetic material 15 to expose the protruding end surfaces of the convexes 25a from the layer of the non-magnetic material 15 (not shown). By doing so, the surface of the preform 80 is smoothed. After this, the protective layer 16 is formed so as to cover the protruding end surfaces of the convexes 25a and the surface of the non-magnetic material 15 filled in the concaves 25b, and then a lubricant is applied onto the surface of the protective layer 16. Next, as one example, by applying a magnetic field in a direction that passes through the magnetic disk 10A in the thickness direction using a DC magnetizing apparatus, the convexes 25a are DC magnetized. By doing so, as shown in FIG. 2, the magnetic disk 10A is completed. After this, by installing the completed magnetic disk 10A inside a case together with the magnetic heads 3 and the like, the hard disk drive 1 is completed.

In the hard disk drive 1 equipped with the magnetic disk 10A described above, the control unit 6 carries out tracking servo control based on the servo data read via the magnetic heads 3 and control data D inside the storage unit 7. More specifically, the control unit 6 controls the controller 2a to rotate the magnetic disk 10A at a fixed angular velocity and controls the driver 5 to drive the actuator 3b and move the magnetic heads 3 to an arbitrary radial position above the magnetic disk 10A. When doing so, the detector unit 4a generates a detection signal S1 by extracting servo data from the output signal S0 (servo signal) outputted from the magnetic heads 3 and outputs the generated detection signal S1 to the control unit 6. The control unit 6 also carries out tracking servo control based on the detection signal S1 (servo data) outputted from the detector unit 4a and the control data D stored in the storage unit 7 to make the magnetic heads 3 on-track to a predetermined track.

When doing so, based on the detection signal S1 (preamble signal) outputted from the detector unit 4a when the preamble pattern region Ap (the “first region” for the present invention) of the magnetic disk 10A passes below the magnetic head 3, the control unit 6 corrects a reference clock for reading a variety of control signals from the servo address mark region Am, the address pattern region Aa, and the like, in accordance with the rotational state (i.e., the rotational velocity) of the magnetic disk 10A and adjusts the gain of the output of the servo data and user data. When doing so, the control unit 6 assumes that the read of the preamble pattern from the preamble pattern region Ap has not ended and continues correcting the reference clock described above based on the detection signal S1 outputted from the detector unit 4a until the detection signal S1 corresponding to the concave 25b of the length L3a described above formed in the servo address mark region Am is outputted from the detector unit 4a.

Accordingly, as described earlier, even if plural convexes 25a that are connected in the direction of rotation via connecting portions 25c are present inside the preamble pattern region Ap of the magnetic disk 10A so that a convex 25a with a length in the direction of rotation equal to the length 11a, for example, is present inside the preamble pattern region Ap, it will still be possible to avoid a situation where the read of the preamble pattern from the preamble pattern region Ap is erroneously judged to have ended based on a signal outputted from the detector unit 4a when such connected convexes pass below the magnetic head 3 (in this example, a detection signal S1 with three times the length of the detection signal S1 corresponding to one convex 25a inside the preamble pattern region Ap). Therefore, it is possible to avoid a situation where the detection signal S1 outputted from the detector unit 4a when convexes 25a disposed on the servo address mark region Am side of the connected convexes 25a pass below the magnetic head 3 are erroneously detected as servo address marks read from the servo address mark region Am.

On the other hand, when the concave 25b of the length L3a described above passes below the magnetic head 3 due to the rotation of the magnetic disk 10A, the control unit 6 judges that the read of the preamble pattern from the preamble pattern region Ap has ended based on the detection signal S1 outputted from the detector unit 4a when the concave 25b of the length L3a passes. When doing so, the control unit 6 identifies that the detection signal S1 outputted from the detector unit 4a after such detection signal S1 is servo data corresponding to the servo address marks read from the servo address mark region Am on the magnetic disk 10A and the address pattern read from the address pattern region Aa that follows afterward, and carries out tracking servo control based on such control data D to make the magnetic head 3 on-track to a desired track.

In this way, according to the magnetic disk 10A and the hard disk drive 1 equipped with the magnetic disk 10A, a concave 25b (i.e., a “second non-recording region”) whose length in the direction of rotation is the length L3a that is longer than a length L2a in the direction of rotation of the concaves 25b (“first non-recording regions”) inside the preamble pattern region Ap at corresponding same-pattern-radius positions is provided at a position (in this example, a front position of the servo address mark region Am) that is adjacent in the direction of rotation to the first region on the magnetic disk 10A (a region where convexes 25a that are long in the radial direction are disposed at the pitch Pa with the concaves 25b in between: in this example, the preamble pattern region Ap) and where the read of the servo data is carried out following the first region described above. By doing so, when manufacturing the magnetic disk 10A where the formation pitch of the convexes 25a inside the servo pattern regions As is sufficiently reduced to increase the recording density, even if the irradiation amount of the electron beam EB at a position corresponding to a concave 25b inside the preamble pattern region Ap of the magnetic disk 10A is insufficient when drawing the concave forming pattern Ep, resulting in a state where plural convexes 25a inside the preamble pattern region Ap become connected via a connecting portion 25c, it will still be possible to avoid a situation where it is erroneously judged, based on the servo data read when a position where the convexes 25a are connected via the connecting portion 25c (a position where the length in the direction of rotation of the convexes 25a that are continuous in the direction of rotation is longer than the length in the direction of rotation of one convex 25a) passes below the magnetic head 3, that a read of the preamble pattern from the preamble pattern region Ap has ended.

Also, according to the magnetic disk 10A and the hard disk drive 1 equipped with the magnetic disk 10A, the control unit 6 judges that a read of preamble data in the servo data has ended when servo data corresponding to the concave 25b of the length L3a described above has been read by the magnetic head 3. By doing so, even when plural convexes 25a become connected via a connecting portion 25c due to the formation pitch of the convexes 25a inside the preamble pattern region Ap being sufficiently reduced to increase the recording density, it will still be possible to correctly read the various servo data from the servo pattern regions As and as a result it will be possible to reliably avoid a situation where tracking servo control errors occur.

Also, according to the magnetic disk 10A and the hard disk drive 1 equipped with the magnetic disk 10A, by providing the concave 25b of the length L3a described above at a position that is adjacent to the preamble pattern region Ap in the direction of rotation and where a read of servo data is carried out following the servo data inside the preamble pattern region Ap (in this example, the front position of the servo address mark region Am provided after the preamble pattern region Ap), unlike a construction where a concave 25b corresponding to the second non-recording region for the present invention is provided far from the preamble pattern region Ap, there will be no convexes 25a and concaves 25b where servo data is recorded present between (i) the region (the preamble pattern region Ap) where convexes 25a and concaves 25b for preamble patterns are aligned in the direction of rotation where connecting portions 25c are likely to occur during manufacturing and (ii) the concave 25b that corresponds to the second non-recording region for the present invention. This means that it is possible to reliably read the servo data from the region (in this example, the servo address mark region Am) in which the servo data is recorded following the region (i.e., the preamble pattern region Ap) in which the convexes 25a for the preamble pattern are disposed at the pitch Pa with the concaves 25b in between.

Also, according to the magnetic disk 10A and the hard disk drive 1 equipped with the magnetic disk 10A, by setting the length L3a in the direction of rotation of the concave 25b that corresponds to the second non-recording region for the present invention equal to or longer than the formation pitch (the pitch Pa) (in this example, the length L3a=pitch Pa) of the convexes 25a for the preamble pattern at same-pattern-radius positions, compared to a magnetic disk where the length in the direction of rotation of the concave 25b corresponding to the second non-recording region for the present invention is only slightly longer than the length L2a of the concaves 25b used in the preamble pattern, the time required for the concave 25b that corresponds to the second non-recording region to pass below the magnetic head 3 will be sufficiently long, and therefore it will be possible to reliably detect the signal when the concave 25b that corresponds to the second non-recording region passes below the magnetic head 3. In this way, according to the magnetic disk 10A and the hard disk drive 1 equipped with the magnetic disk 10A, it is possible to reliably avoid a situation where it is erroneously judged, based on the servo data read when a position where the convexes 25a are connected via a connecting portion 25c passes below the magnetic head 3, that a read of the preamble pattern from the preamble pattern region Ap has ended.

In addition, according to the magnetic disk 10A and the hard disk drive 1 equipped with the magnetic disk 10A, by setting the length L3a in the direction of rotation of the concave 25b that corresponds to the second non-recording region for the present invention at N times (N is two in the present example) the length L2a in the direction of rotation of the concaves 25b used in the preamble patterns at the corresponding same-pattern-radius positions, unlike a construction where the length L3a in the direction of rotation of the concave 25b that corresponds to the second non-recording region for the present invention is set at a non-natural number multiple (such as 1.5 times) the length L2a in the direction of rotation of the concaves 25b in the preamble pattern at the same-pattern-radius positions, it will be possible to read the servo data from the entire servo pattern region As without having to switch between plural reference clocks to read the servo data from the servo pattern region As. By doing so, according to the magnetic disk 10A and the hard disk drive 1, it is possible not only to easily carry out tracking servo control but also to sufficiently lower the manufacturing cost of the hard disk drive 1 by an amount corresponding to it being no longer necessary to use control data D of a complex data structure.

Next, another embodiment of an information recording medium and a recording/reproducing apparatus according to the present invention will be described with reference to the drawings. Note that component elements that are the same as in the magnetic disk 10A and the hard disk drive 1 described earlier have been assigned the same reference numerals and duplicated description thereof is omitted.

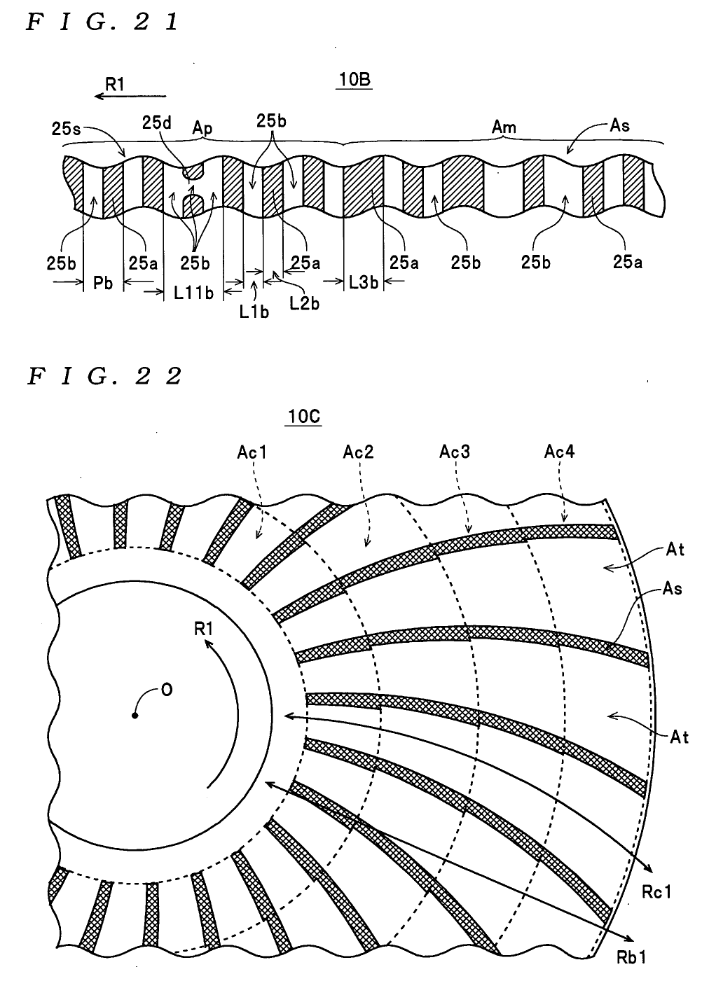

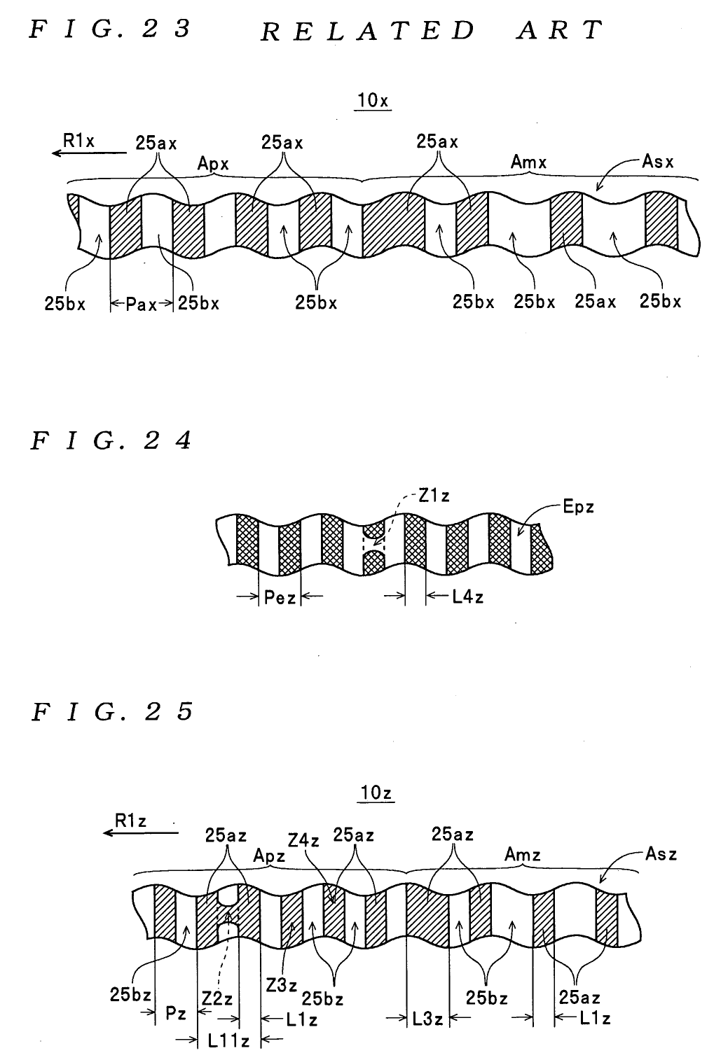

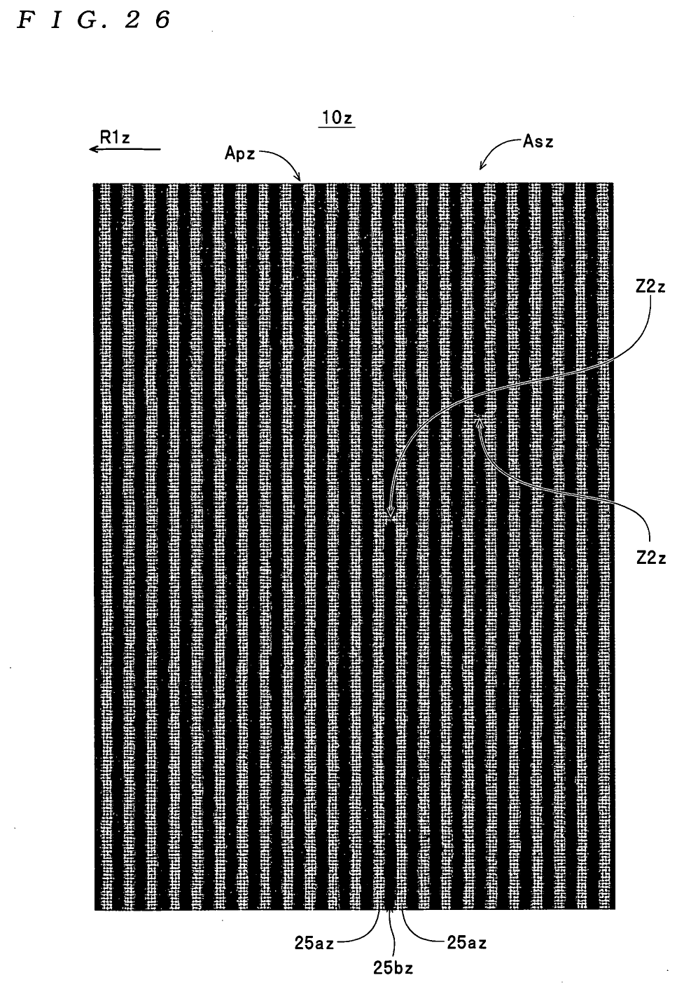

A magnetic disk 10B shown in FIGS. 1 to 4 and FIG. 21 is another example of an information recording medium according to the present invention and is manufactured according to substantially the same method of manufacturing as the magnetic disk 10A described earlier. In the same way as on the magnetic disk 10A described earlier, formation regions of the convexes 25a on the magnetic disk 10B correspond to “recording regions” for the present invention and formation regions of the concaves 25b correspond to “non-recording regions” for the present invention. Also, on the magnetic disk 10B, as one example, in two regions that are the preamble pattern region Ap and the servo address mark region Am of the servo pattern regions As, the formation positions of the convexes 25a and the formation positions of the concaves 25b are reversed compared to the magnetic disk 10A described earlier. More specifically, on the magnetic disk 10B, the concaves 25b are formed at positions where the convexes 25a are formed in the preamble pattern region Ap and the servo address mark region Am of the magnetic disk 10A described earlier and the convexes 25a are formed at positions where the concaves 25b are formed in the preamble pattern region Ap and the servo address mark region Am of the magnetic disk 10A. Note that in FIG. 4 that is used to describe one example of the arrangement of the servo patterns for the present invention, for ease of understanding the present invention, the differences in the formation positions described above of the convexes 25a and the concaves 25b between the magnetic disks 10A and 10B are not considered.

In this case, on the magnetic disk 10B, the entire preamble pattern region Ap is formed of a “second region” for the present invention and the convexes 25a and the concaves 25b are alternately disposed between one end and the other end in the direction of rotation of the preamble pattern region Ap corresponding to the preamble signal used as servo data. More specifically, in the preamble pattern region Ap of the magnetic disk 10B, plural belt-shaped concaves 25b (one example of “third non-recording regions” for the present invention) that are long in the radial direction of the magnetic disk 10B (the up-down direction in both figures: the direction of the arrow Rb1 shown in FIG. 3) are disposed at a pitch Pb (one example of a “predetermined pitch” for the present invention) with the convexes 25a (one example of “third recording regions” for the present invention) in between. Note that the concaves 25b (the third non-recording regions for the present invention) described above in the preamble pattern region Ap are formed in reality of belt-like shapes (one example of a state that is “long in the radial direction” for the present invention) that are long in arc-shaped paths (the arc-shaped line shown by the arrow Rc1 in FIG. 3) traced when the magnetic head 3 described above moves between the inner periphery and the outer periphery of the magnetic disk 10B.

In this case, in the servo pattern 25s that constructs the preamble pattern, as one example, at a position where the distance from the center O (see FIG. 3) of the data track patterns 25t is 15 mm (one example of a “pattern radius position” for the present invention), the pitch Pb (a “predetermined pitch” for the present invention) in the direction of rotation of the concaves 25b is set at 110 nm, the length L1b along the direction of rotation of the concaves 25b is set at 55 nm corresponding to the servo data “0”, and the length L2b along the direction of rotation of the convexes 25a is set at 55 nm corresponding to the servo data “1”. Note that the pitch Pb described above of the concaves 25b formed in the preamble pattern region Ap is set so as to be equal at same-pattern-radius positions where the distance from the center O of the data track patterns 25t is equal and so as to increase from the inner periphery region of the magnetic disk 10B to the outer periphery region of the magnetic disk 10B. In addition, the length L1b described above of the concaves 25b formed in the preamble pattern region Ap is set so as to be equal at same-pattern-radius positions where the distance from the center O of the data track patterns 25t is equal and so as to increase from the inner periphery region of the magnetic disk 10B to the outer periphery region of the magnetic disk 10B. In the same way, the length L2b described above of the convexes 25a formed in the preamble pattern region Ap is set so as to be equal at same-pattern-radius positions where the distance from the center O of the data track patterns 25t is equal and so as to increase from the inner periphery region of the magnetic disk 10B to the outer periphery region of the magnetic disk 10B.

On the magnetic disk 10B, the concaves 25b of the length L1b and the convexes 25a of the length L2b described above are formed so as to be alternately disposed up to a servo address mark region Am end of the preamble pattern region Ap, and a concave 25b of the length L1b described above that corresponds to a “third non-recording region” for the present invention is formed at the servo address mark region Am end of the preamble pattern region Ap. In addition, on the magnetic disk 10B, the concaves 25b inside the preamble pattern region Ap are formed as described above at the extremely narrow pitch Pb. This means that for the magnetic disk 10B, as described later, during manufacturing, at some positions inside the preamble pattern region Ap, a connecting portion 25d is formed by a concave 25b (one example of a “fourth non-recording region” for the present invention) so that concaves 25b that are adjacent in the direction of rotation become connected in the direction of rotation. In this case, as described above, since the length L1b of the concaves 25b at a position where the distance from the center O of the data track patterns 25t is 15 mm is 55 nm and the length L2b of the convexes 25a is 55 nm, when a connecting portion 25d is formed at a position where the distance from the center O is 15 mm, the length L11b where concaves 25b are continuous along the direction of rotation is 165 nm.

Also, on the magnetic disk 10B, as described earlier, the concaves 25b are formed at positions where the convexes 25a are formed inside the servo address mark regions Am of the magnetic disk 10A and the convexes 25a are formed at positions where the concaves 25b are formed inside the servo address mark regions Am of the magnetic disk 10A. Accordingly, on the magnetic disk 10B, in place of the concave 25b with the length L3a on the magnetic disk 10A described earlier, a convex 25a corresponding to a fourth recording region for the present invention is formed at a front region of the servo address mark region Am (the preamble pattern region Ap end in the direction of rotation: one example of a “position where a read of the servo data is carried out following the servo data inside the preamble pattern region” for the present invention), with such convex 25a being used to identify the end of a read of a preamble pattern from the preamble pattern region Ap. Note that the length L3b of the convex 25a that corresponds to the “fourth recording region” for the present invention at a position where the distance from the center O of the data track patterns 25t is 15 mm is set at 110 nm that is equal to the pitch Pb described above and twice the length L2b of the convexes 25a inside the preamble pattern region Ap described above (one example where “N times” for the present invention is “twice”).

When manufacturing the magnetic disk 10B described above, as one example, a child stamper (not shown) similar to the stamper 60 fabricated when manufacturing the magnetic disk 10A described earlier is fabricated using a metal material (for example, nickel) and injection molding is carried out using this child stamper to fabricate a stamper to be used for imprinting for forming a mask pattern in the B1 mask forming layer 33 on the matrix 30. When doing so, as described above, on the magnetic disk 10B, the formation positions of the convexes 25a and the concaves 25b in two regions that are the preamble pattern region Ap and the servo address mark region Am are reversed compared to the magnetic disk 10A described above. Also, when manufacturing a magnetic disk 10B manufactured by carrying out a pattern transferring process an odd number of times counting from the silicon substrate 31 in the state where the concave/convex pattern 37 has been formed, in the first concave forming pattern Ep (not shown) to be drawn when fabricating a stamper, the electron beam EB is irradiated onto regions corresponding to the convexes 25a in the concave/convex pattern 25. Accordingly, in the concave forming pattern Ep drawn when fabricating the stamper for manufacturing the magnetic disk 10B, the positions irradiated with the electron beam EB match the concave forming pattern Ep for the magnetic disk 10A described above in regions corresponding to two regions that are the preamble pattern region Ap and the servo address mark region Am, and the positions irradiated with the electron beam EB differ from the concave forming pattern Ep for the magnetic disk 10A described above in regions corresponding to the servo pattern regions As aside from the preamble pattern region Ap and the servo address mark region Am and also the data track pattern regions At.

In this case, as described above, since the formation pitch (i.e., the pitch Pb) of the concaves 25b on the magnetic disk 10B is extremely small in the same way as the formation pitch (i.e., the pitch Pa) of the convexes 25a on the magnetic disk 10A, in the concave forming pattern Ep drawn during the fabrication of the stamper for manufacturing the magnetic disk 10B also, in the same way as the position shown by the arrow Z1 in FIG. 7, a situation occurs where the irradiation amount of the electron beam EB is insufficient at some positions corresponding to the convexes 25a used in the preamble patterns on the magnetic disk 10B. Accordingly, on a resin stamper for imprinting that has been fabricated using the concave forming pattern Ep, unlike the stamper 60 (imprinting process resin stamper) for fabricating the magnetic disk 10A described above, defects where the convexes for forming the preamble patterns on the resin stamper are connected in the direction of rotation will be produced. For this reason, as described above, on the magnetic disk 10B, due to the imprinting process being carried out using a stamper on which such defects have been produced, a state where plural concaves 25b that are adjacent in the direction of rotation inside the preamble pattern region Ap are connected via the connecting portions 25d (i.e., a state where concaves 25b are formed at positions where convexes 25a should be formed) will be produced. Note that since this method of manufacturing of the magnetic disk 10B is the same as the method of manufacturing the magnetic disk 10a described earlier except for the concave forming pattern Ep drawn during the manufacturing of the stamper and the stamper manufactured using such concave forming pattern Ep, illustration and detailed description of such method are omitted.

In the hard disk drive 1 equipped with the magnetic disk 10B, based on the detection signal S1 (preamble signal) outputted from the detector unit 4a when the preamble pattern region Ap (the “second region” for the present invention) of the magnetic disk 10B passes below the magnetic head 3, the control unit 6 corrects a reference clock for reading a variety of control signals from the servo address mark region Am, the address pattern region Aa, and the like in accordance with the rotational state (i.e., the rotational velocity) of the magnetic disk 10B and adjusts the gain of the output of the servo data and the user data. When doing so, the control unit 6 assumes that the read of the preamble patterns from the preamble pattern region Ap has not ended and continues correcting the reference clock described above based on the detection signal S1 outputted from the detector unit 4a until the detection signal S1 corresponding to the convex 25a of the length L3b described above formed in the servo address mark region Am is outputted from the detector unit 4a.

Accordingly, as described earlier, even if plural concaves 25b that are connected in the direction of rotation via connecting portions 25d are present inside the preamble pattern region Ap of the magnetic disk 10B so that a concave 25b with a length in the direction of rotation equal to the length 11b, for example, is present inside the preamble pattern region Ap, it will still be possible to avoid a situation where the read of the preamble pattern from the preamble pattern region Ap is erroneously judged to have ended based on a signal outputted from the detector unit 4a when such connected concaves pass below the magnetic head 3 (in this example, a detection signal S1 with three times the length of the detection signal S1 corresponding to one concave 25b inside the preamble pattern region Ap). Therefore, it is possible to avoid a situation where the detection signal S1 outputted from the detector unit 4a when a concave 25b disposed closer to the servo address mark region Am side than the concaves 25b connected via the connecting portion 25d passes below the magnetic head 3 is erroneously detected as a servo address mark read from the servo address mark region Am.

On the other hand, when the convex 25a of the length L3b described above passes below the magnetic head 3 due to the rotation of the magnetic disk 10B, the control unit 6 judges that the read of the preamble pattern from the preamble pattern region Ap has ended based on the detection signal S1 outputted from the detector unit 4a when the convex 25a of the length L3b passes. When doing so, the control unit 6 identifies that the detection signal S1 outputted from the detector unit 4a after such detection signal S1 is servo data corresponding to the servo address marks read from the servo address mark region Am on the magnetic disk 10B and the address pattern read from the address pattern region Aa that follows afterward, and carries out tracking servo control based on the control data D to make the magnetic head 3 on-track to a desired track.

In this way, according to the magnetic disk 10B and the hard disk drive 1 equipped with the magnetic disk 10B, a convex 25a (i.e., a “fourth non-recording region”) whose length in the direction of rotation is the length L3b that is longer than a length L2b in the direction of rotation of the convexes 25a (“third recording regions”) inside the preamble pattern region Ap at corresponding same-pattern-radius positions is provided at a position (in this example, a front position of the servo address mark region Am) that is adjacent in the direction of rotation to the second region on the magnetic disk 10B (a region where concaves 25b that are long in the radial direction are disposed at the pitch Pb with the convexes 25a in between: in this example, the preamble pattern region Ap) and where the read of the servo data is carried out following the second region described above. By doing so, when manufacturing the magnetic disk 10B where the formation pitch of the concaves 25b inside the servo pattern regions As is sufficiently reduced to increase the recording density, even if the irradiation amount of the electron beam EB at a position corresponding to a convex 25a inside the preamble pattern region Ap of the magnetic disk 10B is insufficient when drawing the concave forming pattern Ep, resulting in a state where plural concaves 25b inside the preamble pattern region Ap are connected via a connecting portion 25d, it will still be possible to avoid a situation where it is erroneously judged, based on the servo data read when a position where the concaves 25b are connected via the connecting portion 25d (a position where the length in the direction of rotation of the connected concaves 25b is longer than the length in the direction of rotation of one concave 25a) passes below the magnetic head 3, that a read of the preamble pattern from the preamble pattern region Ap has ended.

Also, according to the magnetic disk 10B and the hard disk drive 1 equipped with the magnetic disk 10B, the control unit 6 judges that a read of preamble data in the servo data has ended when servo data corresponding to the convex 25a of the length L3b described above has been read by the magnetic head 3. By doing so, even when plural concaves 25b become connected via a connecting portion 25d due to the formation pitch of the concaves 25b inside the preamble pattern region Ap being sufficiently reduced to increase the recording density, it will still be possible to correctly read the various servo data from the servo pattern regions As and as a result it will be possible to reliably avoid a situation where tracking servo control errors occur.

Also, according to the magnetic disk 10B and the hard disk drive 1 equipped with the magnetic disk 10B, by providing the convex 25a of the length L3b described above at a position that is adjacent to the preamble pattern region Ap in the direction of rotation and where a read of servo data is carried out following the servo data inside the preamble pattern region Ap (in this example, the front position of the servo address mark region Am provided after the preamble pattern region Ap), unlike a construction where a convex 25a corresponding to the fourth recording region for the present invention is provided far from the preamble pattern region Ap, there will be no convexes 25a and concaves 25b where servo data is recorded between (i) the region (the preamble pattern region Ap) where convexes 25a and concaves 25b for preamble patterns are aligned in the direction of rotation where connecting portions 25d are likely to occur during manufacturing and (ii) the convex 25a that corresponds to the fourth recording region for the present invention. This means that it is possible to reliably read the servo data from the region (in this example, the servo address mark region Am) in which the servo data is recorded following the region (i.e., the preamble pattern region Ap) in which the concaves 25b for the preamble pattern are disposed at the pitch Pb with the convexes 25a in between.

Also, according to the magnetic disk 10B and the hard disk drive 1 equipped with the magnetic disk 10B, by setting the length L3b in the direction of rotation of the convex 25a that corresponds to the fourth recording region for the present invention equal to or longer than the formation pitch (the pitch Pb) (in this example, the length L3b=pitch Pb) of the concaves 25b for the preamble pattern at same-pattern-radius positions, compared to a magnetic disk where the length in the direction of rotation of the convex 25a corresponding to the fourth recording region for the present invention is only slightly longer than the length L2b of the convexes 25a used in the preamble pattern, the time required for the convex 25a that corresponds to the fourth recording region to pass below the magnetic head 3 will be sufficiently long, and therefore it will be possible to reliably detect the signal when the convex 25a that corresponds to the fourth recording region passes below the magnetic head 3. In this way, according to the magnetic disk 10B and the hard disk drive 1, it is possible to reliably avoid a situation where it is erroneously judged, based on the servo data read when a position where the concaves 25b are connected via a connecting portion 25d, that a read of the preamble pattern from the preamble pattern region Ap has ended.

In addition, according to the magnetic disk 10B and the hard disk drive 1 equipped with the magnetic disk 10B, by setting the length L3b in the direction of rotation of the convex 25a that corresponds to the fourth recording region for the present invention at N times (N is two in the present example) the length L2b in the direction of rotation of the convexes 25a in the preamble pattern at the corresponding same-pattern-radius positions, unlike a construction where the length L3b in the direction of rotation of the convex 25a that corresponds to the fourth recording region for the present invention is set at a non-natural number multiple (such as 1.5 times) the length L2b in the direction of rotation of the convexes 25a in the preamble pattern at the same-pattern-radius positions, it will be possible to read the servo data from the entire servo pattern region As without having to switch between plural reference clocks to read the servo data from the servo pattern region As. By doing so, according to the magnetic disk 10B and the hard disk drive 1, it is possible not only to easily carry out tracking servo control but also to sufficiently lower the manufacturing cost of the hard disk drive 1 by an amount corresponding to it being no longer necessary to use control data D of a complex data structure.

Note that the present invention is not limited to the construction and method described above. For example, although the magnetic disk 10A where the concave 25b with the length L3a corresponding to the second non-recording region for the present invention is provided at the front position of the servo address mark region Am (a position closest to the preamble pattern region Ap in the servo address mark region Am that is provided adjacent to the preamble pattern region Ap) and the magnetic disk 10B where the convex 25a with the length L3b corresponding to the fourth recording region for the present invention is provided at the front position of the servo address mark region Am (a position closest to the preamble pattern region Ap in the servo address mark region Am that is provided adjacent to the preamble pattern region Ap) have been described as examples, the positions of the second non-recording region and the fourth recording region for the present invention are not limited to such. For example, it is possible to use a construction where the second non-recording region or the fourth recording region is provided at a position where a read of servo data is carried out last in the preamble pattern region (i.e., a construction where the second non-recording region or the fourth recording region is part of the preamble pattern). It is also possible to use a construction where the position at which the second non-recording region or the fourth recording region is provided is set between the preamble pattern region and another servo pattern (for example, the servo address mark region) provided following the preamble pattern region.

Even when such construction is used, in the same way as the magnetic disk 10A or 10B and the hard disk drive 1 equipped with the magnetic disk 10A or 10B described above, even if the magnetic disk is manufactured with a sufficiently reduced formation pitch for the convexes or concaves inside the servo pattern regions to increase the recording density and the amount of irradiation of the electron beam EB at positions corresponding to the concaves or positions corresponding to the convexes inside the preamble pattern region of the magnetic disk becomes insufficient during the drawing of the concave forming pattern, resulting in a state where plural convexes or plural concaves are connected via a connecting portion inside the preamble pattern region, it will still be possible to avoid a situation where it is erroneously judged, based on the servo data read when a position where the convexes or concaves are connected via the connecting portion passes below the magnetic head, that a read of the preamble pattern from the preamble pattern region has ended.

Also, although the magnetic disks 10A, 10B where the convexes 25a of the concave/convex pattern 25 (that is, the data track patterns 25t and the servo pattern 25s) are entirely formed of the magnetic layer 14 (magnetic material) from the protruding end portions to the base end portions thereof have been described as examples, the construction of the information recording medium according to the present invention is not limited to this. As a specific example, it is possible to construct the data track patterns 25t and the servo patterns 25s described above of a concave/convex pattern (not shown) including convexes whose protruding end portions are composed of the magnetic layer 14 and whose base end portions are composed of the intermediate layer 13 and/or the soft magnetic layer 12 and concaves whose base surfaces are formed inside the thickness of the intermediate layer 13 and/or the soft magnetic layer 12. It is also possible to construct the data track patterns 25t and the servo patterns 25s from a concave/convex pattern (not shown) where not only the convexes but also the base surfaces of the concaves are formed of the magnetic layer 14.

In addition, by forming a thin magnetic layer 14 so as to cover a concave/convex pattern formed in the glass substrate or the like (a concave/convex pattern where the concaves and convexes have the same positional relationship as the concave/convex pattern 25), it is possible to construct the concave/convex pattern 25 (the data track patterns 25t and the servo patterns 25s: not shown) from plural convexes whose surfaces are formed of magnetic material and plural concaves whose base surfaces are formed of the magnetic material. It is also possible to construct the concave/convex pattern 25 (the data track patterns 25t and the servo patterns 25s: not shown) from plural convexes where only the protruding end portions of convexes of the concave/convex pattern formed in a glass substrate or the like are formed of the magnetic layer 14 and the base end portions are formed of a non-magnetic material or a soft magnetic material. In addition, it is possible to construct the concave/convex pattern 25 (the data track patterns 25t and the servo patterns 25s: not shown) by forming the magnetic layer 14 not only on the protruding end portions of convexes of a concave/convex pattern formed in a glass substrate or the like but also on the base surfaces of the concaves (i.e., by forming the magnetic layer 14 on surfaces aside from the side surfaces of the convexes).

In addition, it is also possible to construct a magnetic disk (not shown) by filling concaves of a concave/convex pattern formed in a layer of non-magnetic material with the magnetic material that constructs the magnetic layer 14 described above and setting the positions of the convexes in the layer of the non-magnetic material as the non-recording regions (i.e., regions corresponding to the concaves 25b of the magnetic disk 10A or the like) and positions of the magnetic material filled in the concaves as the recording regions (i.e., regions corresponding to the convexes 25a of the magnetic disk 10A or the like). Also, although examples where the magnetic disks 10A, 10B are manufactured by carrying out imprinting using a stamper manufactured using the concave forming pattern Ep drawn by irradiation with the electron beam EB and then carrying out etching using the formed mask pattern have been described, the information recording medium according to the present invention is not limited to a medium manufactured by an etching process. More specifically, as one example, a mask pattern may be formed on the magnetic layer by carrying out imprinting using a stamper manufactured using the concave forming pattern Ep and an ion irradiation process, a reaction process that uses reactive gas, or the like may be carried out using the mask pattern to selectively modify positions where the magnetic layer is exposed from the mask pattern. By carrying out such processes, it is also possible to construct a magnetic disk (not shown) by forming regions whose ability to hold a magnetic signal in a readable manner is lower than that of the periphery thereof or regions that effectively cannot hold a magnetic signal, setting regions whose ability to hold a magnetic signal in a readable manner is high as recording regions, and setting regions whose ability to hold a magnetic signal in a readable manner is low as non-recording regions.

Also, although the magnetic disks 10A, 10B have been described where the length of each data track pattern region At along the direction of rotation of the magnetic disks and the length of each servo pattern region As along the direction of rotation are set so as to increase as the distance from the center O of the data track patterns 25t increases (i.e., the data track pattern regions At and the servo pattern regions As are set so as to widen from an inner periphery region to an outer periphery region) in proportion to the length of a part of the magnetic disk 10 that passes below the magnetic head 3 per unit time, the construction of the information recording medium according to the present invention is not limited to this. For example, a magnetic disk 10C shown in FIG. 22 is partitioned into plural (in this example, four) ring-shaped regions Ac1 to Ac4 (hereinafter collectively referred to as the “ring-shaped regions Ac” when no distinction is required) centered on the center O of the data track patterns, and the servo pattern regions As and the data track pattern regions At are set separately for each ring-shaped region Ac. On this magnetic disk 10C, in the ring-shaped regions Ac2 to Ac4, the length along the direction of rotation in the inner periphery of such ring-shaped region Ac is shorter than the length along the direction of rotation in the outer periphery of a ring-shaped region Ac located to the inside of such ring-shaped region Ac. Also, on the magnetic disk 10C, in each ring-shaped region Ac, the length of the servo pattern regions As along the direction of rotation is set so as to increase as the distance from the center O increases in proportion to the length of a part of the magnetic disk 10C that passes below the magnetic head 3 per unit time (i.e., so that the length of the servo pattern regions As gradually increases from the inner periphery to the outer periphery). Note that the arrow Rb1 in FIG. 22 shows the radial direction of the magnetic disk 10C, and the arrow Rc1 shows a line that matches an arc-shaped path traced when the magnetic head 3 described above moves between the inner periphery and the outer periphery of the magnetic disk 10C.

In this case, on the magnetic disks 10A, 10B described above where the length along the direction of rotation of the servo pattern regions As gradually increases from the innermost periphery to the outermost periphery, the lengths along the direction of rotation of the convexes 25a and the concaves 25b inside each preamble pattern region Ap gradually increase toward the outer periphery. For this reason, in the concave forming pattern Ep drawn when manufacturing the stampers described above for manufacturing the magnetic disks 10A, 10B, the length along the direction of rotation of regions sufficiently irradiated with the electron beam EB until the resist layer is eliminated during the developing process gradually increases toward the outer periphery. Accordingly, when drawing the concave forming pattern Ep used to manufacture the magnetic disks 10A, 10B, it is possible to avoid a situation where irradiation with the electron beam EB is insufficient (i.e., the reason why the connecting portions 25c, 25d described above are formed) at the outer periphery of the concave forming pattern Ep.

On the other hand, on the magnetic disk 10C described above, in the ring-shaped regions Ac2 to Ac4 that are further outside than the ring-shaped region Ac1, the length along the direction of rotation of the servo pattern regions As is set shorter than at corresponding pattern radius positions in the servo pattern regions As of the magnetic disks 10A, 10B. This means that in the concave forming pattern drawn when manufacturing a stamper for manufacturing a magnetic disk 10C, the length along the direction of rotation of regions sufficiently irradiated with the electron beam EB until the resist layer is eliminated during the developing process becomes shorter in the ring-shaped regions Ac2 to Ac4 that are further outside than the ring-shaped region Ac1. Accordingly, during the drawing of a concave forming pattern for manufacturing the magnetic disk 10C, there is the risk of positions where the irradiation of the electron beam EB is insufficient being produced in the outer periphery also, and due to this, connecting portions that are the same as the connecting portions 25c, 25d described above may be formed in the preamble pattern region Ap. For this reason, by applying the present invention to the magnetic disk 10C, even if a connecting portion is formed inside a preamble pattern region Ap in the outer periphery of the magnetic disk 10C, it will be possible to avoid a situation where it is erroneously judged that a read of a preamble pattern from the preamble pattern region Ap has ended.

What is claimed is:

1. An information recording medium on which servo patterns, in which recording regions and non-recording regions are disposed corresponding to servo data, are formed in servo pattern regions, comprising:
a first region where first recording regions that are long in a radial direction of the information recording medium are disposed at a predetermined pitch with first non-recording regions in between in a preamble pattern region provided in each servo pattern region; and
a second recording region that connects the first recording regions that are adjacent in a direction of rotation of the information recording medium, the second recording region being provided in the first region,
wherein a second non-recording region is provided at a position that is adjacent in the direction of rotation to the first region and where a read of the servo data is carried out following the first region, and
a length in the direction of rotation of the second non-recording region is longer than a length in the direction of rotation of the first non-recording regions at corresponding same-pattern-radius positions.

2. The information recording medium according to claim 1,
wherein the second non-recording region is provided at one of:
a position where a read of the servo data in the preamble pattern region is carried out last; and
a position that is adjacent in the direction of rotation to the preamble pattern region and where a read of the servo data is carried out following the servo data inside the preamble pattern region.

3. The information recording medium according to claim 1,
wherein the length in the direction of rotation of the second non-recording region is equal to or longer than the predetermined pitch at same-pattern-radius positions.

4. The information recording medium according to claim 1,
wherein the length in the direction of rotation of the second non-recording region is a length that is N times the length in the direction of rotation of the first non-recording regions at corresponding same-pattern-radius positions, where N is a natural number of 2 or higher.

5. An information recording medium on which servo patterns, in which recording regions and non-recording regions are disposed corresponding to servo data, are formed in servo pattern regions, comprising:
a second region where third non-recording regions that are long in a radial direction of the information recording medium are disposed at a predetermined pitch with third recording regions in between in a preamble pattern region provided in each servo pattern region; and
a fourth non-recording region that connects the third non-recording regions that are adjacent in a direction of rotation of the information recording medium, the fourth non-recording region being provided in the second region,
wherein a fourth recording region is provided at a position that is adjacent in the direction of rotation to the second region and where a read of the servo data is carried out following the second region, and
a length in the direction of rotation of the fourth recording region is longer than a length in the direction of rotation of the third recording regions at corresponding same-pattern-radius positions.

6. The information recording medium according to claim 5,
wherein the fourth recording region is provided at one of:
a position where a read of the servo data in the preamble pattern region is carried out last; and
a position that is adjacent in the direction of rotation to the preamble pattern region and where a read of the servo data is carried out following the servo data inside the preamble pattern region.

7. The information recording medium according to claim 5,
wherein the length in the direction of rotation of the fourth recording region is equal to or longer than the predetermined pitch at same-pattern-radius positions.

8. The information recording medium according to claim 5,
wherein the length in the direction of rotation of the fourth recording region is a length that is N times the length in the direction of rotation of the third recording regions at corresponding same-pattern-radius positions, where N is a natural number of 2 or higher.

9. A recording/reproducing apparatus comprising:
the information recording medium according to claim 1;
a magnetic head that reads the servo data from the servo pattern regions; and
a control unit that carries out tracking servo control based on the read servo data.

10. The recording/reproducing apparatus according to claim 9,
wherein the control unit judges that a read of preamble data out of the servo data has ended when the servo data corresponding to the second non-recording region is read by the magnetic head.

11. A recording/reproducing apparatus comprising:
the information recording medium according to claim 5;
a magnetic head that reads the servo data from the servo pattern regions; and
a control unit that carries out tracking servo control based on the read servo data.

12. The recording/reproducing apparatus according to claim 11,
wherein the control unit judges that a read of preamble data out of the servo data has ended when the servo data corresponding to the fourth recording region is read by the magnetic head.
